(19) United States
(12) Patent Application Publication
(10) Pub. No.: US 2026/0253093 A1
(43) Pub. Date: Aug. 27, 2026

(54) SYSTEM

(71) Applicant: SoftBank Group Corp., Tokyo (JP)

(72) Inventor: Kei KYUSHIMA, Tokyo (JP)

(73) Assignee: SoftBank Group Corp., Tokyo (JP)

(21) Appl. No.: 19/537,504

(22) Filed: Feb. 12, 2026

(30) Foreign Application Priority Data
Feb. 21, 2025 (JP) 2025-027072

(51) Int. Cl. G06Q 30/02

(52) U.S. Cl. CPC G06Q 30/02

(57) ABSTRACT

A system according to an embodiment includes a collection unit, an analysis unit, a generation unit, and a provision unit. The collection unit collects user search data or interaction data with a generative AI. The analysis unit analyzes the data collected by the collection unit and identifies user hobbies and preferences. The generation unit generates an advertisement based on the hobbies and preferences identified by the analysis unit. The provision unit provides the advertisement generated by the generation unit to the user.

### CROSS-REFERENCE TO RELATED APPLICATION

The present application claims priority to and incorporates by reference the entire contents of Japanese Patent Application No. 2025-027072 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, generating advertisements based on user hobbies and preferences has not been sufficiently performed, and there is room for improvement.

### SUMMARY OF THE INVENTION

A system according to an embodiment includes a collection unit, an analysis unit, a generation unit, and a provision unit. The collection unit collects user search data or interaction data with a generative AI. The analysis unit analyzes the data collected by the collection unit and identifies user hobbies and preferences. The generation unit generates an advertisement based on the hobbies and preferences identified by the analysis unit. The provision unit provides the advertisement generated by the generation unit to the user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

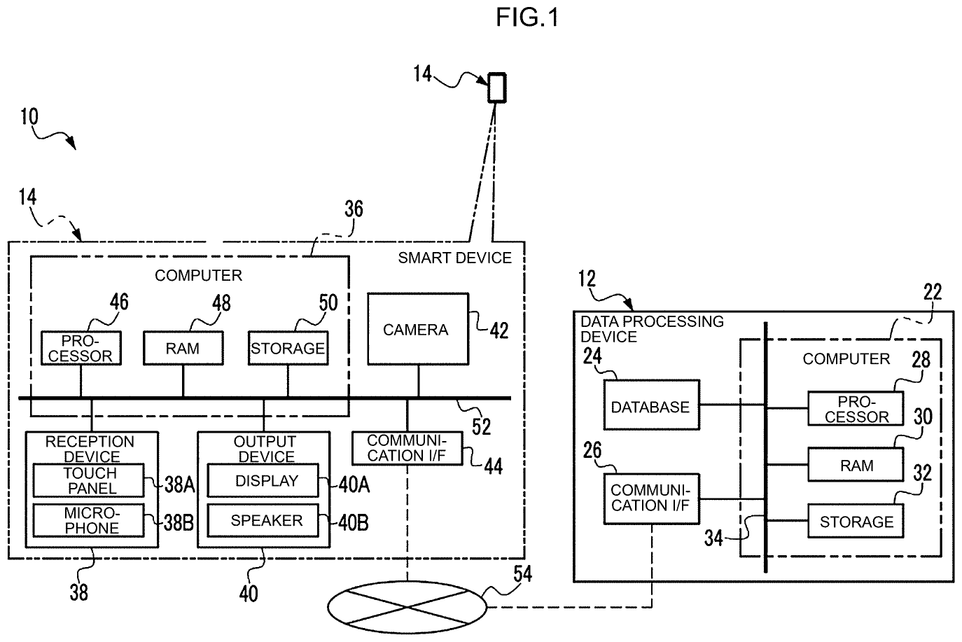

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

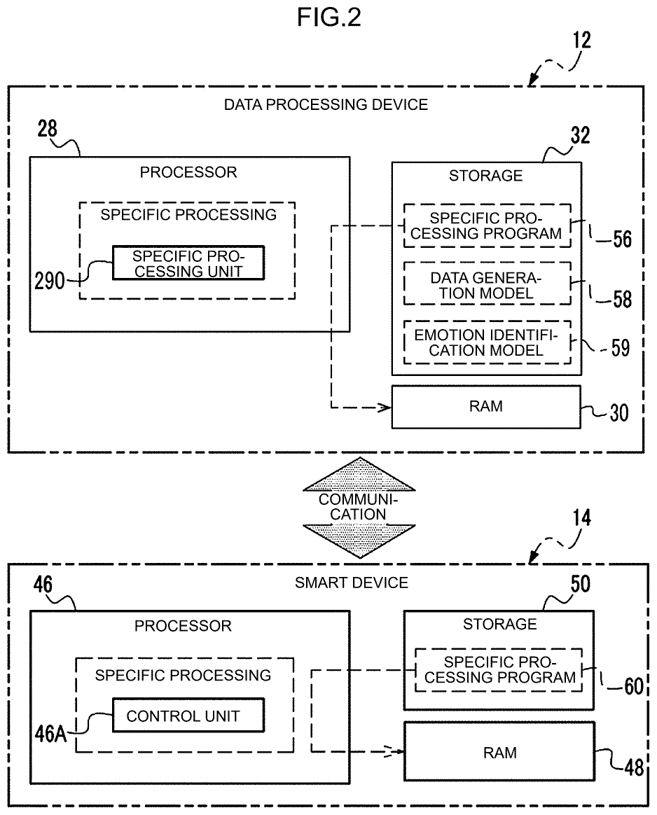

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The advertisement generation system according to the embodiment of the present invention is a system that analyzes user search data and interaction data with a generative AI, and automatically generates an advertisement tailored to individual hobbies and preferences. This advertisement generation system collects user search data and interaction data with a generative AI, and the generative AI analyzes the data to identify user hobbies and preferences. Next, the generative AI generates an advertisement based on the identified hobbies and preferences, and the generated advertisement is displayed on a web page or an application viewed by the user. For example, the advertisement generation system collects user search data and interaction data with a generative AI. For example, keywords input by the user in a search engine and interaction content with the generative AI can be collected. Next, the advertisement generation system analyzes the collected data using the generative AI to identify user hobbies and preferences. The generative AI can identify topics and products in which the user is interested from, for example, the user's search history and interaction content. Next, the advertisement generation system generates an advertisement based on the hobbies and preferences identified using the generative AI. The generative AI can automatically create an advertisement related to a product or service in which the user is interested, for example. Finally, the advertisement generation system provides the generated advertisement to the user. For example, the generated advertisement is displayed on a web page or an application viewed by the user. Thereby, an advertiser can provide an effective advertisement to a target user, and the user can receive an advertisement matching their interests. Thereby, the advertisement generation system can analyze user search data and interaction data with a generative AI, and automatically generate an advertisement tailored to individual hobbies and preferences. Specifically, this advertisement generation system adopts a composite AI architecture integrating a plurality of neural network models including a Large Language Model (LLM) specialized in natural language processing and an image generation model, and analyzes potential needs of the user within a high-dimensional feature space. Input data to this system is a numerical vector sequence (e.g., a 768-dimensional or 1024-dimensional embedding vector) obtained by tokenizing a query character string input by the user into a search engine, or time-series text data including an interaction with an interactive AI such as a chatbot. This system performs context analysis on these input data using an encoder based on a Transformer architecture, and outputs a “hobbies and preferences feature vector” representing user interests. This feature vector is expressed as an affinity score for a specific product category (e.g., outdoor goods, financial services, etc.) or a probability distribution indicating a user's current purchasing desire level. Furthermore, this system inputs the identified hobbies and preferences feature vector as a Conditioning Input to a generative AI such as a Diffusion Model or a Generative Adversarial Network (GAN). The generative AI automatically generates pixel data of an advertisement image (e.g., a 1024×1024×3 RGB tensor) and text data of an advertisement copy that match the user's preferences based on the input vector. As subsequent processing, this system performs quality scoring on the generated advertisement content, and distributes only content exceeding a predetermined threshold to an advertisement slot on a browser or an application of a user terminal in real time. Through this series of processing, it becomes possible to dynamically reflect minute contexts of the user and temporary changes in interest, which were difficult to capture with conventional static rule-based targeting, and a technical effect of significantly improving a Click-Through Rate (CTR) and a Conversion Rate (CVR) of the advertisement is achieved.

The advertisement generation system according to the embodiment comprises a collection unit, an analysis unit, a generation unit, and a provision unit. The collection unit collects user search data and interaction data with a generative AI. The user search data includes, for example, keywords input in a search engine and a search history. The interaction data with the generative AI includes, for example, content of an interaction performed by the user with the generative AI and a history of the interaction. The collection unit collects these data and provides them to the analysis unit. The analysis unit analyzes the data collected by the collection unit and identifies user hobbies and preferences. The analysis unit identifies topics and products in which the user is interested from the user's search history and interaction content using, for example, natural language processing technology. The analysis unit can use a generative AI to identify user hobbies and preferences. The generative AI analyzes the user's search history and interaction content using, for example, a text generation AI (e.g., LLM) to identify user hobbies and preferences. The generation unit generates an advertisement based on the hobbies and preferences identified by the analysis unit. The generation unit automatically creates an advertisement related to a product or service in which the user is interested, for example. The generation unit can generate an advertisement using a generative AI. The generative AI generates an advertisement based on user hobbies and preferences using, for example, a text generation AI (e.g., LLM). The provision unit provides the advertisement generated by the generation unit to the user. The provision unit displays the generated advertisement on a web page or an application viewed by the user, for example. The provision unit can provide an advertisement using a generative AI. Thereby, the advertisement generation system according to the embodiment can analyze user search data and interaction data with a generative AI, and automatically generate an advertisement tailored to individual hobbies and preferences. Specifically, this collection unit has a function of acquiring a user operation log as real-time stream data via a web browser plugin or an application API hook, converting this into structured data (JSON format, etc.), and storing it in a data lake. This analysis unit comprises a preprocessing module that performs morphological analysis and syntax analysis on the collected text data, and an inference engine obtained by fine-tuning a pre-trained LLM. An input to the analysis unit is a token sequence including user search queries and interaction logs for the past several days, and an output from the analysis unit is a multidimensional vector including a score value in a range of 0 to 1 indicating a degree of interest for each user interest topic (e.g., “camping”, “investment”). This generation unit converts this interest degree vector into a prompt (instruction sentence) and inputs it to an image generation AI and a text generation AI, thereby generating an advertisement creative having visual and linguistic elements matching the user's interest. This provision unit dynamically distributes the generated advertisement creative in accordance with layout information (DOM structure, etc.) of content currently being viewed by the user via a Real-Time Bidding (RTB) system or an ad server. In this way, by organically combining each unit as a data pipeline centered on an AI model, a technical effect of providing an advertisement experience optimized for each individual user at a speed and scale impossible with manual advertisement production and operation is realized.

The advertisement generation system further comprises a privacy protection unit configured to protect user privacy in a process of collecting and analyzing data. The privacy protection unit protects user privacy in the process of collecting and analyzing data. The privacy protection unit protects user privacy using methods such as data anonymization, encryption, and access restriction, for example. Data anonymization is a method of converting data so that user personal information cannot be identified. For example, personal information such as a user's name and address is deleted and replaced with an anonymous identifier. Data encryption is a method of encrypting data so that a third party cannot decrypt the data. For example, data is encrypted using an encryption algorithm so that only a person having an encryption key can decrypt the data. Access restriction is a method of restricting access to data. For example, users who can access data are limited so that only a person having access authority can access the data. Thereby, the privacy protection unit can protect user privacy in the process of collecting and analyzing data. Part or all of the above-described processing in the privacy protection unit may be performed using, for example, AI, or may be performed without using AI. For example, the privacy protection unit can protect user privacy using an AI model that performs data anonymization or encryption. Specifically, this privacy protection unit implements a neural network model that performs Named Entity Recognition (NER), and detects Personally Identifiable Information (PII) such as a name, an address, and a telephone number from input text data with high accuracy. An input to this model is text data of a user search query or an interaction log, and an output is position information and a category label (e.g., [PERSON], [LOCATION]) of a token corresponding to PII. As subsequent processing, this privacy protection unit automatically executes a masking process of replacing the detected PII with a random character string or a generalized category name, or a statistical anonymization process such as k-anonymity or l-diversity. Furthermore, this privacy protection unit applies Differential Privacy technology and injects statistical noise (Laplace noise, etc.) into a dataset, thereby maintaining statistical usefulness of the entire data while concealing individual user data. In addition, by using Homomorphic Encryption, it becomes possible to perform inference and learning by an AI model while keeping data encrypted, eliminating a risk of exposure of plaintext data throughout the entire analysis process. This achieves a technical effect of balancing high-level personalization and strict privacy protection.

The advertisement generation system further comprises a feedback collection unit configured to collect user feedback and measure an effect of the advertisement. The feedback collection unit collects user feedback and measures the effect of the advertisement. The feedback collection unit collects feedback such as user evaluation, comments, and click-through rates, for example. The user evaluation is an evaluation performed by the user on the advertisement, and is represented by, for example, the number of stars or a score. The user comment is a comment made by the user on the advertisement, and includes, for example, opinions and impressions on the content of the advertisement. The click-through rate is a ratio of the number of clicks to the number of times the advertisement is displayed, and is an index for measuring the effect of the advertisement. The feedback collection unit collects these feedbacks and measures the effect of the advertisement. Thereby, the feedback collection unit can collect user feedback and measure the effect of the advertisement. Part or all of the above-described processing in the feedback collection unit may be performed using, for example, AI, or may be performed without using AI. For example, the feedback collection unit can measure the effect of the advertisement using an AI model that analyzes user evaluations and comments. Specifically, this feedback collection unit generates data contributing to an update of a Reward Model in a framework of Reinforcement Learning (RL). An input to this feedback collection unit is presence/absence of a click on the advertisement by the user (binary value), a dwell time after advertisement display (numerical value), presence/absence of conversion, and a text comment input by the user. This feedback collection unit analyzes the text comment using a natural language processing model (e.g., a BERT-based sentiment analysis model) and outputs a positive/negative/neutral sentiment score (e.g., a continuous value from −1.0 to +1.0). In addition, it integrates behavioral indices such as the click-through rate and dwell time with the sentiment score to calculate a comprehensive “Reward Scalar” for the advertisement. This reward value is used for fine-tuning (RLHF: Reinforcement Learning from Human Feedback) of an advertisement generation model (generative AI) in subsequent processing. That is, weight parameters of the model are updated so as to learn features of an advertisement for which a high reward value was obtained and suppress features of an advertisement with a low reward value. Thereby, the system exhibits a technical effect of learning user preferences more deeply as operation continues and autonomously improving accuracy of advertisement generation.

The collection unit is configured to estimate a user emotion and adjust a collection timing of the search data in accordance with the estimated user emotion. For example, when the user is relaxed, the collection unit frequently collects search data to acquire detailed data. For example, when the user feels stressed, the collection unit reduces a collection frequency of search data to reduce a burden on the user. For example, when the user is excited, the collection unit collects search data in real time and analyzes an immediate reaction. Thereby, the collection unit can adjust the collection timing of search data according to the user emotion. The estimation of emotion is realized using an emotion estimation function using, for example, an emotion engine or a generative AI. The generative AI is a text generation AI (e.g., LLM) or a multimodal generative AI, but is not limited to such examples. Part or all of the above-described processing in the collection unit may be performed using, for example, AI, or may be performed without using AI. For example, the collection unit can input user facial expression data to a generative AI and cause the generative AI to execute estimation of the user emotion. Specifically, this collection unit comprises an emotion estimation AI model that receives multimodal data such as image data (face image tensor) acquired from a camera of a user device, audio data (waveform data or spectrogram) acquired from a microphone, and a keystroke rhythm (time-series numerical data) of keyboard input. This emotion estimation AI has an architecture combining a Convolutional Neural Network (CNN) and a Recurrent Neural Network (RNN), extracts feature quantities from input data, and outputs two-dimensional coordinate values of “Arousal” and “Valence” in Russell's circumplex model, or a probability distribution of basic emotion categories such as “joy”, “anger”, “sadness”, and “relaxation”. As subsequent processing, this collection unit executes an algorithm for dynamically controlling a sampling rate (frequency) of data collection based on the output emotion state. For example, when the emotion is determined to be “relaxation (low arousal/positive valence)”, the sampling rate is increased from once per second to 10 times per second to collect a detailed operation log, while when it is determined to be “stress (high arousal/negative valence)”, background processing is suppressed to lower a device load, and the collection frequency is reduced so as not to impair user experience. In this way, by adaptively changing system operation using the internal state of the user emotion state as a trigger, a technical effect of efficiently collecting high-quality data while minimizing invasiveness to the user is obtained.

The collection unit is configured to analyze a past search history of the user and select an appropriate collection method. For example, the collection unit preferentially collects related data based on keywords frequently searched by the user in the past. For example, the collection unit analyzes a tendency for searches to concentrate in a specific time zone from the user's search history, and concentrates collection in that time zone. For example, the collection unit analyzes the user's search history and intensively collects data related to a specific category. Thereby, the collection unit can analyze the user's past search history and select an optimal collection method. Part or all of the above-described processing in the collection unit may be performed using, for example, AI, or may be performed without using AI. For example, the collection unit can input user search history data to a generative AI and cause the generative AI to execute selection of an optimal collection method. Specifically, this collection unit analyzes a user's past search log (query list with timestamps) using a time-series data prediction model (e.g., LSTM: Long Short-Term Memory or a Transformer-based time-series model). An input to this model is a time-series vector of search activity over the past several weeks to several months, and an output from the model is a predicted value of a user activity level in a specific future time frame (e.g., the next one hour) or a probability distribution of keyword categories likely to be searched. As subsequent processing, this collection unit optimizes scheduling of crawling and data acquisition based on this prediction result. For example, in a time zone where the predicted activity level is high, a polling interval for data acquisition is shortened, and conversely, in a time zone where activity is predicted to be low (sleeping hours, etc.), polling is stopped and the system shifts to a sleep mode. Also, when it is predicted that a search probability for a specific category (e.g., “movies” on weekends) is high, a collection target is dynamically switched to perform prefetch (pre-acquisition) from an external data source (movie review site, etc.) related to that category. This enables efficient data management that collects necessary data without omission while suppressing wasteful consumption of calculation resources and network bandwidth.

The collection unit is configured to perform filtering based on a current field of interest of the user when collecting the search data. For example, the collection unit preferentially collects data related to a topic in which the user is currently interested. For example, the collection unit filters unnecessary data based on the user's current field of interest and collects data efficiently. For example, when the user's field of interest changes, the collection unit updates a filtering condition in real time and collects the latest data. Thereby, the collection unit enables efficient data collection by filtering data based on the user's current field of interest. Part or all of the above-described processing in the collection unit may be performed using, for example, AI, or may be performed without using AI. For example, the collection unit can input user interest field data to a generative AI and cause the generative AI to execute setting of a filtering condition. Specifically, this collection unit utilizes a topic classification model (e.g., a model applying BERTopic or LDA: Latent Dirichlet Allocation) arranged in a real-time stream processing engine. An input to this model is text of a web page recently viewed by the user or an input search query, and an output is an ID of a topic cluster to which the text belongs and a belonging probability to each topic. This collection unit holds a “current interest vector” of the user, and calculates a cosine similarity with a topic vector of newly input data. As subsequent processing, a filtering process is executed in which only data whose calculated similarity exceeds a predetermined threshold (e.g., 0.7) is passed as “relevant data” and saved in a database, while data below the threshold is discarded as noise. Furthermore, when the user's interest transitions, such as from “travel” to “cooking”, the interest vector is updated using an Exponential Moving Average (EMA) or the like based on the latest data, and the filtering criterion is made to dynamically follow. This achieves a technical effect of constructing a high-purity dataset contributing to analysis accuracy while saving storage capacity.

The collection unit is configured to estimate a user emotion and determine a priority of data to be collected based on the estimated user emotion. For example, when the user is relaxed, the collection unit preferentially collects detailed data. For example, when the user feels stressed, the collection unit preferentially collects only important data. For example, when the user is excited, the collection unit adjusts a priority of data to be collected in real time. Thereby, the collection unit can determine the priority of data to be collected according to the user emotion. The estimation of emotion is realized using an emotion estimation function using, for example, an emotion engine or a generative AI. The generative AI is a text generation AI (e.g., LLM) or a multimodal generative AI, but is not limited to such examples. Part or all of the above-described processing in the collection unit may be performed using, for example, AI, or may be performed without using AI. For example, the collection unit can input user facial expression data to a generative AI and cause the generative AI to execute estimation of the user emotion. Specifically, this collection unit comprises a data collection scheduler using a Priority Queue, and dynamically calculates a priority score of each data collection task based on a user emotion state. As an input, an emotion label (e.g., “relaxation”, “stress”) output from an emotion estimation AI and metadata (data size, importance tag) of a data source to be a collection candidate are received. For example, when the user is in a “relaxation” state, this collection unit determines that a risk that a system load due to data collection adversely affects user experience is low, and adds a positive weight to a priority score of a high-load/large-capacity detailed log collection task. Conversely, when the user is in a “stress” state, a negative penalty is given to a priority score of a collection task other than an essential system log so as not to hinder user operability, and execution is delayed or canceled. As subsequent processing, tasks in the queue are sorted based on the calculated priority scores, and executed sequentially from a higher-ranked task. This resource allocation logic based on emotion recognition enables intelligent background processing control considering the user's psychological state, improving user acceptance of the entire system.

The collection unit is configured to preferentially collect highly relevant data based on geographical location information of the user when collecting the search data. For example, when the user is in a specific area, the collection unit preferentially collects data related to that area. For example, the collection unit collects data on trends and events specific to an area based on the user's geographical location information. For example, when the user is traveling, the collection unit preferentially collects data related to a visited area. Thereby, the collection unit can preferentially collect highly relevant data by considering the user's geographical location information. Part or all of the above-described processing in the collection unit may be performed using, for example, AI, or may be performed without using AI. For example, the collection unit can input user geographical location information to a generative AI and cause the generative AI to execute collection of highly relevant data. Specifically, this collection unit receives GPS coordinates (latitude/longitude), Wi-Fi access point information, or location information acquired from an IP address as an input, and determines a user's current location and movement context (“home”, “workplace”, “moving”, “travel destination”, etc.) using geofencing technology and location information clustering algorithms (e.g., DBSCAN or K-means). This collection unit accesses a regional information database or an event API using the determined area ID or context information as a query, and extracts keywords (place name, store name, name of event being held) related to the area. As subsequent processing, search data or social media posts including the extracted area-related keywords are added to a collection target list with a higher priority than normal data. For example, when it is determined that the user is staying in “Kyoto”, a collection depth of data including keywords related to Kyoto such as “temple”, “matcha”, and “kimono rental” is automatically deepened. This provides a technical effect of reflecting a context of physical location information in a data collection strategy in cyberspace and increasing acquisition accuracy of information matching the user's immediate needs.

The collection unit is configured to analyze social media activity of the user and collect relevant data when collecting the search data. For example, the collection unit collects data related to a topic frequently mentioned by the user on social media. For example, the collection unit collects data on interested events and trends from the user's social media activity. For example, the collection unit preferentially collects data related to accounts and groups followed by the user. Thereby, the collection unit can efficiently collect relevant data by analyzing the user's social media activity. Part or all of the above-described processing in the collection unit may be performed using, for example, AI, or may be performed without using AI. For example, the collection unit can input user social media activity data to a generative AI and cause the generative AI to execute collection of relevant data. Specifically, this collection unit has a function of analyzing a user's social graph and interest graph using a Graph Neural Network (GNN). Input data is user posted text, engagement history such as “likes”, and graph structure data (list of nodes and edges) representing follow/follower relationships. The GNN model performs message passing on this graph structure to learn and update a latent representation vector (embedding representation) of a user node. This latent representation vector becomes a value reflecting a topic (potential interest) in which others close on the social network are interested, even if the user does not directly mention it. As subsequent processing, this collection unit identifies a topic category having high similarity with this latent representation vector, and activates a crawler that actively collects external web data and news articles related to the category. This makes it possible to collect potential trends of which the user is not yet clearly aware or information popular within a belonging community in advance, improving novelty and discoverability (serendipity) of recommendation.

The analysis unit is configured to estimate a user emotion and adjust a data analysis method based on the estimated user emotion. For example, when the user is relaxed, the analysis unit performs detailed data analysis to obtain deep insight. For example, when the user feels stressed, the analysis unit performs simplified data analysis to provide a result quickly. For example, when the user is excited, the analysis unit performs data analysis in real time to provide immediate feedback. Thereby, the analysis unit can adjust the data analysis method according to the user emotion. The estimation of emotion is realized using an emotion estimation function using, for example, an emotion engine or a generative AI. The generative AI is a text generation AI (e.g., LLM) or a multimodal generative AI, but is not limited to such examples. Part or all of the above-described processing in the analysis unit may be performed using, for example, AI, or may be performed without using AI. For example, the analysis unit can input user facial expression data to a generative AI and cause the generative AI to execute adjustment of the data analysis method. Specifically, this analysis unit holds a plurality of analysis models having different calculation costs and accuracies (e.g., a lightweight logistic regression model, a medium-scale random forest, a large-scale deep learning model), and comprises a model selector function that dynamically switches a model to be used according to a user emotion state. An emotion estimation result (emotion class and confidence) is received as an input, and for example, when a state of “stress” or “hurry” is detected, a lightweight model with a small calculation amount and high inference speed is selected to minimize latency (response delay), thereby speeding up analysis processing. On the other hand, when it is estimated that there is time to spare in a “relaxation” state, a Large Language Model (LLM) having billions of parameters is selected to execute deep semantic analysis and inference from multiple perspectives. As subsequent processing, an analysis result by the selected model is passed to the generation unit. This adaptive model selection provides a balance between response speed and information depth optimal for the user's psychological situation, achieving a technical effect of balancing efficient operation of system resources (GPU/CPU usage rate) and maximization of user satisfaction.

The analysis unit is configured to adjust a level of detail of analysis based on an importance of the data during analysis. For example, the analysis unit performs detailed analysis on data with high importance to provide a highly accurate result. For example, the analysis unit performs simplified analysis on data with low importance to provide a result efficiently. For example, the analysis unit optimally allocates resources for analysis according to the importance of data. Thereby, the analysis unit can adjust the level of detail of analysis based on the importance of data. Part or all of the above-described processing in the analysis unit may be performed using, for example, AI, or may be performed without using AI. For example, the analysis unit can adjust the level of detail of analysis using an AI model that evaluates the importance of data. Specifically, this analysis unit comprises a preprocessing AI that applies an Attention Mechanism to input data (text, image, etc.) and calculates an importance score (Attention Weight) of each data element. This importance score is a numerical value from 0 to 1 indicating how much the data contributes to identifying user hobbies and preferences. For “high importance data” whose calculated importance score exceeds a predetermined threshold, this analysis unit executes full-path inference using all layers of a deep neural network to perform semantic detailed analysis. On the other hand, for “low importance data” falling below the threshold, an Early Exit method using only shallow layers of the network or a simple algorithm such as simple keyword matching is applied. As subsequent processing, these analysis results are integrated to update a user profile. This layering of processing based on importance allows calculation resources to be concentrated on important parts even for a huge dataset, achieving a technical effect of significantly improving throughput (processing capacity) of the entire system while maintaining analysis accuracy.

The analysis unit is configured to apply different analysis algorithms according to a category of the data during analysis. For example, the analysis unit applies a natural language processing algorithm to text data. For example, the analysis unit applies an image recognition algorithm to image data. For example, the analysis unit applies a voice recognition algorithm to audio data. Thereby, the analysis unit enables highly accurate analysis by applying different analysis algorithms according to the category of data. Part or all of the above-described processing in the analysis unit may be performed using, for example, AI, or may be performed without using AI. For example, the analysis unit can perform data analysis using an AI model that applies an analysis algorithm according to the category of data. Specifically, this analysis unit comprises a Router module corresponding to multimodal input, and analyzes a MIME type or header information of input data to determine a modality (text, image, audio, video) of the data. For text data, a Transformer-based BERT or GPT model is applied to extract a semantic vector. For image data, a CNN (e.g., ResNet or EfficientNet) or ViT (Vision Transformer) is applied to perform object detection or scene recognition, generating an image feature vector. For audio data, natural language processing is performed after converting to text (STT) using a voice recognition model such as Wav2Vec, or acoustic features are directly extracted. As subsequent processing, feature vectors extracted from each modality are mapped to a common Latent Space to perform multimodal Fusion, thereby comprehensively understanding complex user interests that cannot be captured by a single modality. This integration of modality-specific processing achieves a technical effect of extracting maximum information from various formats of data and enhancing robustness and comprehensiveness of analysis.

The analysis unit is configured to estimate a user emotion and determine a priority of analysis based on the estimated user emotion. For example, when the user is relaxed, the analysis unit preferentially performs detailed analysis. For example, when the user feels stressed, the analysis unit preferentially performs analysis of important data. For example, when the user is excited, the analysis unit preferentially performs real-time analysis. Thereby, the analysis unit can determine the priority of analysis according to the user emotion. The estimation of emotion is realized using an emotion estimation function using, for example, an emotion engine or a generative AI. The generative AI is a text generation AI (e.g., LLM) or a multimodal generative AI, but is not limited to such examples. Part or all of the above-described processing in the analysis unit may be performed using, for example, AI, or may be performed without using AI. For example, the analysis unit can input user facial expression data to a generative AI and cause the generative AI to execute determination of the priority of analysis. Specifically, this analysis unit implements a dynamic scheduler incorporating an emotion variable into a task scheduling algorithm. As an input, an emotion status (e.g., Emotion_ID=“Anger”) from an emotion estimation module and a data queue waiting for analysis are received. When the user shows a negative emotion such as “anger” or “dissatisfaction”, this analysis unit assigns the highest priority (Priority_Level=High) to an analysis task of the latest interaction data for identifying the cause, and immediately executes analysis to generate information for taking a countermeasure (stopping advertisement or switching to apologetic content). On the other hand, in the case of “joy” or “neutral”, a long-term preference analysis task is scheduled to be executed in the background. As subsequent processing, a directive to the generation unit is issued based on the prioritized analysis result. This provides a technical effect of optimizing system responsiveness according to user emotional urgency, preventing a chain of negative experiences, and reinforcing positive experiences.

The analysis unit is configured to determine a priority of analysis based on a collection time of the data during analysis. For example, the analysis unit preferentially analyzes the latest data and provides a real-time result. For example, the analysis unit analyzes past data and grasps a long-term trend. For example, the analysis unit preferentially analyzes data collected in a specific period and clarifies a tendency of that period. Thereby, the analysis unit enables efficient analysis by determining the priority of analysis based on the collection time of data. Part or all of the above-described processing in the analysis unit may be performed using, for example, AI, or may be performed without using AI. For example, the analysis unit can determine the priority of analysis using an AI model that evaluates the collection time of data. Specifically, this analysis unit uses a timestamp of data as an input, and calculates a “freshness score” of each data using a Time Decay Function (e.g., an exponential decay model) that attenuates importance according to elapsed time from the current time. This analysis unit assigns a high analysis priority to data with a high freshness score (i.e., the latest data), and inputs it to an immediate analysis pipeline for capturing a user's “now” interest (micro-moment). On the other hand, past data with a low freshness score is routed to a batch processing pipeline and used to learn long-term preference changes and seasonality. As subsequent processing, a result of immediate analysis and a result of long-term trend analysis are weighted and integrated to construct a user model in which short-term impulses and long-term preferences are balanced. This prioritization considering the time axis achieves a technical effect of maximizing freshness value of information while efficiently allocating calculation resources.

The analysis unit is configured to adjust an order of analysis based on a relevance of the data during analysis. For example, the analysis unit preferentially analyzes data having high relevance and provides a highly accurate result. For example, the analysis unit postpones data having low relevance and proceeds with analysis efficiently. For example, the analysis unit optimally allocates resources for analysis according to the relevance of data. Thereby, the analysis unit enables efficient analysis by adjusting the order of analysis based on the relevance of data. Part or all of the above-described processing in the analysis unit may be performed using, for example, AI, or may be performed without using AI. For example, the analysis unit can adjust the order of analysis using an AI model that evaluates the relevance of data. Specifically, this analysis unit comprises a relevance scoring model using a Learning to Rank algorithm. An input to this model is data to be analyzed (document or image) and context information (keyword vector, etc.) of an advertisement campaign currently being targeted. The model calculates a semantic similarity between the input data and the context, and outputs a relevance score. This analysis unit sorts a data processing queue based on this score, and allocates analysis resources in order from data predicted to have high relevance and a large contribution to advertisement generation. As subsequent processing, feature quantities are streamed to the generation unit sequentially from data for which analysis is completed, and an advertisement generation process is started without waiting for completion of analysis of data with low relevance. This achieves a technical effect of shortening latency of the entire processing and reflecting highly relevant information in an advertisement as quickly as possible.

The generation unit is configured to estimate a user emotion and adjust a presentation method of the advertisement based on the estimated user emotion. For example, when the user is relaxed, the generation unit generates an advertisement with a gentle tone. For example, when the user is excited, the generation unit generates a visually stimulating advertisement. For example, when the user feels stressed, the generation unit generates a simple and calm advertisement. Thereby, the generation unit can adjust the presentation method of the advertisement according to the user emotion. The estimation of emotion is realized using an emotion estimation function using, for example, an emotion engine or a generative AI. The generative AI is a text generation AI (e.g., LLM) or a multimodal generative AI, but is not limited to such examples. Part or all of the above-described processing in the generation unit may be performed using, for example, AI, or may be performed without using AI. For example, the generation unit can input user emotion data to a generative AI and cause the generative AI to execute adjustment of the presentation method of the advertisement. Specifically, this generation unit utilizes Style Transfer technology or a conditional image generation model (Conditional GAN, Stable Diffusion, etc.) to dynamically convert a visual style of an advertisement creative or a tone and manner of text. As an input, base advertisement content and a user emotion label (e.g., “Relaxed”) obtained from the emotion estimation unit are received. This generation unit converts the emotion label into a style parameter (modifier of a prompt or saturation/contrast setting value of an image). For example, in the case of “relaxation”, an image based on pastel colors with lowered contrast and text using honorifics and soft phrasing are generated. In the case of “excitement”, vivid colors and an energetic copy frequently using exclamation marks are generated. As subsequent processing, a variation closest to the current user emotion vector is selected from among a plurality of generated variations and output. This provides a technical effect of providing an advertisement expression that resonates (synchronizes) with the user's psychological state, increasing user acceptance, and improving favorability toward a brand.

The generation unit is configured to adjust content of the advertisement based on a level of detail of the user hobbies and preferences when generating the advertisement. For example, when user hobbies and preferences are identified in detail, the generation unit generates a personalized advertisement. For example, when user hobbies and preferences are roughly identified, the generation unit generates a general advertisement. For example, when user hobbies and preferences are unclear, the generation unit generates an advertisement that attracts a wide range of interests. Thereby, the generation unit can adjust the content of the advertisement based on the level of detail of user hobbies and preferences. Part or all of the above-described processing in the generation unit may be performed using, for example, AI, or may be performed without using AI. For example, the generation unit can input user hobbies and preferences data to a generative AI and cause the generative AI to execute adjustment of the content of the advertisement. Specifically, this generation unit has logic to calculate an index (entropy or variance value) evaluating “Granularity” of a user profile and control specificity of a generation prompt according to the granularity. When variance of an input hobbies and preferences vector is small and concentrated in a specific niche field (e.g., “1980s vintage camera”) (high level of detail), this generation unit generates specific and professional advertisement content including a model number and specs of that specific product. Conversely, when the vector is dispersed and preferences are ambiguous (low level of detail), this generation unit generates a more general and comprehensive brand image advertisement based on a superordinate concept category such as “camera” or “photo”. As subsequent processing, a user reaction (click, etc.) to the generated advertisement is monitored, and if a reaction is obtained, the level of detail of preferences is updated one step deeper. This content generation according to the level of detail achieves a technical effect of gradually deepening accuracy of personalization as data is accumulated while avoiding a cold start problem (inappropriate recommendation when data is insufficient).

The generation unit is configured to apply different generation algorithms according to an interest category of the user when generating the advertisement. For example, when the user is interested in sports, the generation unit applies a sports-related advertisement generation algorithm. For example, when the user is interested in music, the generation unit applies a music-related advertisement generation algorithm. For example, when the user is interested in travel, the generation unit applies a travel-related advertisement generation algorithm. Thereby, the generation unit can generate a more effective advertisement by applying different generation algorithms according to the user's interest category. Part or all of the above-described processing in the generation unit may be performed using, for example, AI, or may be performed without using AI. For example, the generation unit can input user interest category data to a generative AI and cause the generative AI to execute application of a generation algorithm. Specifically, this generation unit is configured as a collection (Mixture of Experts) of a plurality of Domain-Specific Generators fine-tuned for each specific domain (field). When a user interest category ID (e.g., Category_ID=“Sports”) is received as an input, a router network selects an appropriate model. For example, in the case of a “sports” category, an image generation model that has learned dynamic composition and lively expression and a text generation model having sporty and powerful vocabulary are selected and executed. In the case of a “fashion” category, a model emphasizing aesthetic sense and trends is selected. As subsequent processing, contents generated by the selected models are integrated to create a final advertisement banner or video. This domain-adaptive approach achieves a technical effect of generating a high-quality advertisement creative that accurately reflects nuances and technical terms specific to each field, which cannot be fully expressed by a general-purpose model.

The generation unit can estimate a user emotion and adjust a length of the advertisement based on the estimated user emotion. For example, the generation unit generates a longer advertisement when the user is relaxed. For example, the generation unit generates a short and concise advertisement when the user is in a hurry. For example, the generation unit generates a visually stimulating short advertisement when the user is excited. Thereby, the generation unit can adjust the length of the advertisement in accordance with the user emotion. The estimation of the emotion is realized using an emotion estimation function using, for example, an emotion engine or a generative AI. The generative AI is a text generative AI (e.g., LLM), a multimodal generative AI, or the like, but is not limited to such examples. Part or all of the above-described processing in the generation unit may be performed using, for example, AI, or may be performed without using AI. For example, the generation unit can input user emotion data into the generative AI and cause the generative AI to execute the adjustment of the length of the advertisement. Specifically, the present generation unit includes a text summarization model and a video trimming AI, and has a function of controlling the number of tokens and playback time of the content to be generated as parameters. As input, the generation unit receives an “Urgency” score or an estimated value of “disposable time” from an emotion estimation unit. When it is determined that the user is “in a hurry”, the present generation unit gives constraints such as “maximum number of tokens=20” or “video within 3 seconds” to the LLM, and causes the LLM to generate short content extracting only the core of information. On the other hand, in the case of a “relaxed” state, the generation unit generates a long text with a story or a video of 30 seconds or more to deepen engagement. As subsequent processing, the generation unit verifies whether the generated content satisfies the constraint of the specified length, and if it exceeds the limit, performs regeneration or automatic trimming. Thereby, a technical effect is obtained in which the density and amount of information are optimized according to the situational context of the user, and the complete view rate or read-through rate of the advertisement is maximized.

The generation unit can determine a priority of the advertisement based on a past advertisement reaction history of the user when generating the advertisement. For example, the generation unit preferentially generates content of an advertisement to which the user has shown a favorable reaction in the past. For example, the generation unit generates an advertisement while avoiding content of an advertisement in which the user was indifferent in the past. For example, the generation unit analyzes the past advertisement reaction history of the user and generates the most effective advertisement. Thereby, the generation unit can determine the priority of the advertisement based on the past advertisement reaction history of the user. Part or all of the above-described processing in the generation unit may be performed using, for example, AI, or may be performed without using AI. For example, the generation unit can input advertisement reaction history data of the user into the generative AI and cause the generative AI to execute the determination of the priority of the advertisement. Specifically, the present generation unit predicts an expected reward value (click probability, etc.) of each advertisement candidate using Collaborative Filtering, Matrix Factorization, or a Contextual Multi-Armed Bandit algorithm. Input data is a sparse matrix of user x advertisement feature amounts or a past interaction log. The present generation unit assigns a high priority score to a new advertisement plan similar to features (color usage, keywords, layout) of an advertisement that led to a click or conversion in the past. Conversely, the generation unit gives a penalty to a plan having features of an advertisement that received a skip or “not interested” feedback, and excludes it from generation candidates. As subsequent processing, the generation unit executes advertisement generation tasks in descending order of the predicted expected reward value, and concentrates limited generation resources on advertisements expected to be most effective. This optimization based on history produces a technical effect of providing an attractive advertisement to the user in a pinpoint manner while reducing wasteful advertisement generation.

The generation unit can adjust an order of the advertisement based on a relevance to the user when generating the advertisement. For example, the generation unit displays an advertisement with high user interest first. For example, the generation unit postpones an advertisement with low user interest. For example, the generation unit optimizes the display order of advertisements based on the user interest. Thereby, the generation unit can generate a more effective advertisement by adjusting the order of the advertisement based on the relevance to the user. Part or all of the above-described processing in the generation unit may be performed using, for example, AI, or may be performed without using AI. For example, the generation unit can input relevance data of the user into the generative AI and cause the generative AI to execute the adjustment of the order of the advertisement. Specifically, the present generation unit has a function of calculating cosine similarity between a plurality of generated advertisement candidates and a current context vector of the user, and performing re-ranking. As input, the generation unit receives a generated advertisement candidate list (each candidate has a vector representation) and a real-time interest vector of the user. The present generation unit performs scoring by emphasizing relevance to a short-term context such as an immediately preceding search query or content of a browsed page, rather than just static hobbies and preferences. As subsequent processing, the generation unit passes the advertisement list sorted in order of score to the provision unit, and controls so that the most relevant one is placed in a first view (a range visible without scrolling) in a carousel advertisement or a list-format advertisement frame. This produces a technical effect of immediately attracting the user's attention, preventing opportunity loss, and maximizing the advertisement effect.

The provision unit can estimate a user emotion and adjust a provision method of the advertisement based on the estimated user emotion. For example, the provision unit provides an advertisement in a gentle tone when the user is relaxed. For example, the provision unit provides a visually stimulating advertisement when the user is excited. For example, the provision unit provides a simple and calm advertisement when the user feels stress. Thereby, the provision unit can adjust the provision method of the advertisement in accordance with the user emotion. The estimation of the emotion is realized using an emotion estimation function using, for example, an emotion engine or a generative AI. The generative AI is a text generative AI (e.g., LLM), a multimodal generative AI, or the like, but is not limited to such examples. Part or all of the above-described processing in the provision unit may be performed using, for example, AI, or may be performed without using AI. For example, the provision unit can input user emotion data into the generative AI and cause the generative AI to execute the adjustment of the provision method of the advertisement. Specifically, the present provision unit includes an adaptive UI engine that dynamically changes rendering parameters of a user interface (UI). As input, the provision unit receives emotion data from the emotion estimation unit and advertisement content to be displayed. When the user feels “stress”, the present provision unit disables intrusive display formats such as pop-ups and auto-play videos, and changes operations of CSS (Cascading Style Sheets) and JavaScript so as to display the advertisement modestly as a static banner advertisement. On the other hand, when the user is in an “excitement” or “exploration mode”, the provision unit enables animation effects and interactive elements (swipable gallery, etc.) to enhance immersion. As subsequent processing, the provision unit transmits HTML/JS code including the adjusted display parameters to a user terminal. This adjustment of the provision method according to the emotion produces a technical effect of enhancing acceptance of the advertisement without impairing user experience (UX).

The provision unit can refer to a browsing history of the user and select an appropriate provision method when providing the advertisement. For example, the provision unit provides a relevant advertisement based on content of a web page browsed by the user in the past. For example, the provision unit preferentially provides an advertisement related to a specific category from the browsing history of the user. For example, the provision unit analyzes the browsing history of the user and selects the most effective advertisement provision method. Thereby, the provision unit can provide a more effective advertisement by referring to the browsing history of the user and selecting the optimal provision method. Part or all of the above-described processing in the provision unit may be performed using, for example, AI, or may be performed without using AI. For example, the provision unit can input browsing history data of the user into the generative AI and cause the generative AI to execute the selection of the provision method of the advertisement. Specifically, the present provision unit learns a correlation between the browsing history of the user (URLs visited in the past, page titles, metadata) and the display format of the advertisement using a context matching algorithm. As input, the provision unit receives a browsing history vector of the user and a list of available advertisement formats (banner, native, video, interstitial). For example, when the user frequently browses a text-based news site, the present provision unit selects a “native advertisement” format that naturally blends in between articles. On the other hand, for a user who frequently browses video sites, the provision unit selects an “in-stream video advertisement”. As subsequent processing, the provision unit lays out advertisement material according to the selected format and distributes it. This format optimization based on history produces a technical effect of realizing advertisement display without discomfort that matches the content consumption habits of the user, leading to avoidance of advertisement blocking and improvement of visibility.

The provision unit can customize a provision method based on device information of the user when providing the advertisement. For example, the provision unit provides an advertisement optimized for mobile when the user uses a smartphone. For example, the provision unit provides an advertisement optimized for a large screen when the user uses a tablet. For example, the provision unit provides an advertisement including detailed information when the user uses a desktop. Thereby, the provision unit can provide a more effective advertisement by customizing the provision method based on the device information of the user. Part or all of the above-described processing in the provision unit may be performed using, for example, AI, or may be performed without using AI. For example, the provision unit can input the device information of the user into the generative AI and cause the generative AI to execute the customization of the provision method of the advertisement. Specifically, the present provision unit analyzes a user agent string and device fingerprint information to identify a screen resolution, aspect ratio, OS, and communication speed (bandwidth) of the device. The provision unit receives these device profiles as input, and uses the generative AI (image resizing/completion model, etc.) to convert the advertisement creative into specifications optimal for the device in real time. For example, in the case of a smartphone (vertical screen), the provision unit crops or extends an image to a vertical aspect ratio (9:16) and enlarges a character size to ensure visibility. In the case of a desktop (horizontal screen), the provision unit uses a horizontal (16:9) high-resolution image and writes a detailed spec table or the like together. When the communication speed is slow, the provision unit increases a compression rate of the image or switches a video to a still image. As subsequent processing, the provision unit distributes the optimized media file via a CDN (Content Delivery Network). This device optimization produces a technical effect of displaying the advertisement without collapsing in any browsing environment and at a comfortable loading speed.

The provision unit can estimate a user emotion and adjust a provision timing of the advertisement based on the estimated user emotion. For example, the provision unit frequently provides advertisements when the user is relaxed. For example, the provision unit reduces a provision frequency of advertisements when the user feels stress. For example, the provision unit provides an advertisement in real time when the user is excited. Thereby, the provision unit can adjust the provision timing of the advertisement in accordance with the user emotion. The estimation of the emotion is realized using an emotion estimation function using, for example, an emotion engine or a generative AI. The generative AI is a text generative AI (e.g., LLM), a multimodal generative AI, or the like, but is not limited to such examples. Part or all of the above-described processing in the provision unit may be performed using, for example, AI, or may be performed without using AI. For example, the provision unit can input user emotion data into the generative AI and cause the generative AI to execute the adjustment of the provision timing of the advertisement. Specifically, the present provision unit includes an intelligent distribution scheduler that performs Interruption Management. As input, the provision unit receives a real-time emotion score and context information of a current task of the user (working, resting, moving, etc.). When it is determined that the user is in a “Flow” state or a “stress” state, the present provision unit blocks interruption by advertisement display and holds a notification in a queue (silent mode). Thereafter, when a timing (breakpoint) at which the emotion changes to “relaxed” or “bored” is detected, the provision unit presents the held advertisement at an appropriate timing. As subsequent processing, the provision unit feeds back a reaction of the user after the advertisement display (whether it was closed immediately or browsed), and updates a threshold of timing determination logic by reinforcement learning. This timing control produces a technical effect of providing information aiming at a moment when attention to the advertisement is most likely to be successful without disturbing the work efficiency or psychological peace of the user.

The provision unit can select an appropriate provision method based on geographical location information of the user when providing the advertisement. For example, when the user is in a specific area, the provision unit provides an advertisement related to the area. For example, the provision unit provides an advertisement related to a region-specific trend or event based on the geographical location information of the user. For example, when the user is traveling, the provision unit provides an advertisement related to a visited area. Thereby, the provision unit can provide a more effective advertisement by selecting the optimal provision method in consideration of the geographical location information of the user. Part or all of the above-described processing in the provision unit may be performed using, for example, AI, or may be performed without using AI. For example, the provision unit can input the geographical location information of the user into the generative AI and cause the generative AI to execute the selection of the provision method of the advertisement. Specifically, the present provision unit cooperates with a Location-Based Service (LBS) to acquire POI (Point of Interest) information around the current location of the user. The provision unit receives GPS coordinates and a movement velocity vector as input, and estimates a detailed situation such as whether the user is “moving in a shopping mall on foot” or “moving by train”. For a user in a shopping mall, for example, the present provision unit provides an advertisement including a time sale coupon usable at a store in the mall or navigation to a store close to the current location. In the case of moving by train, the provision unit provides an advertisement for a restaurant around an arrival station or an e-book readable while moving. As subsequent processing, the provision unit cooperates with a map application API to dynamically embed specific guidance information such as “5 minutes walk from here” in the advertisement. By utilizing this location information and movement context, a technical effect is produced in which online advertisement and offline behavior (O2O: Online to Offline) are seamlessly connected to enhance a customer sending effect to a real store.

The provision unit can analyze social media activity of the user and adjust a provision method when providing the advertisement. For example, the provision unit provides an advertisement related to a topic frequently mentioned by the user on social media. For example, the provision unit provides an advertisement related to an event or trend of interest from the social media activity of the user. For example, the provision unit provides an advertisement related to an account or group followed by the user. Thereby, the provision unit can provide a more effective advertisement by analyzing the social media activity of the user and adjusting the provision method. Part or all of the above-described processing in the provision unit may be performed using, for example, AI, or may be performed without using AI. For example, the provision unit can input social media activity data of the user into the generative AI and cause the generative AI to execute the adjustment of the provision method of the advertisement. Specifically, the present provision unit implements advertisement display logic applying a principle of social proof. As input, the provision unit receives social graph information (list of friends, common interests) of the user. When displaying an advertisement, the present provision unit dynamically generates social context information such as “Your friend A also ‘likes’ this product” or “It is a hot topic in your community” as additional information, and displays it as an overlay on the advertisement creative. Further, when the user follows an influencer's account, the provision unit selects an advertisement format that introduces a product in a style recommended by the influencer. As subsequent processing, the provision unit automatically performs an A/B test of an advertisement including a social element and an advertisement not including it, and learns a highly effective pattern. By adding this social context, a technical effect of fostering trust and affinity for the advertisement and improving a click rate is obtained.

The privacy protection unit can estimate a user emotion and adjust a method of privacy protection based on the estimated user emotion. For example, the privacy protection unit performs detailed data collection and adjusts a level of privacy protection when the user is relaxed. For example, the privacy protection unit minimizes data collection and strengthens the level of privacy protection when the user feels stress. For example, the privacy protection unit adjusts the method of privacy protection in real time when the user is excited. Thereby, the privacy protection unit can adjust the method of privacy protection in accordance with the user emotion. The estimation of the emotion is realized using an emotion estimation function using, for example, an emotion engine or a generative AI. The generative AI is a text generative AI (e.g., LLM), a multimodal generative AI, or the like, but is not limited to such examples. Part or all of the above-described processing in the privacy protection unit may be performed using, for example, AI, or may be performed without using AI. For example, the privacy protection unit can input user emotion data into the generative AI and cause the generative AI to execute the adjustment of the method of privacy protection. Specifically, the present privacy protection unit interprets a user emotion state as an index of “Privacy Sensitivity” and controls a dynamic privacy policy application engine. Upon receiving an emotion score as input, if the user shows an emotion of “anxiety” or “caution”, the system shifts to a “high security mode”. In this mode, the unit raises anonymization strength of data (k value of k-anonymity), temporarily suspends external transmission of data, and limits processing to within a local device (edge AI processing). Conversely, in a state of “trust” or “relaxation”, the unit permits data processing on the cloud side for more accurate personalization within the scope of user consent settings. As subsequent processing, the unit notifies the user of the applied privacy protection level (e.g., “Data collection is currently minimal”) to provide a sense of security. This emotion-linked protection control produces a technical effect of addressing the user's psychological privacy concerns and maintaining/improving trust in the system.

The privacy protection unit can adjust a level of detail of protection based on an importance of the data during privacy protection. For example, the privacy protection unit performs detailed privacy protection for data with high importance. For example, the privacy protection unit performs simplified privacy protection for data with low importance. For example, the privacy protection unit optimally allocates resources for privacy protection according to the importance of the data. Thereby, the privacy protection unit can adjust the level of detail of protection based on the importance of the data. Part or all of the above-described processing in the privacy protection unit may be performed using, for example, AI, or may be performed without using AI. For example, the privacy protection unit can adjust the level of detail of protection using an AI model that evaluates the importance of data. Specifically, the present privacy protection unit automatically determines a Confidentiality Level of each collected data item using a Data Classification AI model. Input data is unstructured data such as text, images, and logs, and the model classifies them into classes such as “PII (Personally Identifiable Information)”, “sensitive information (health, finance, etc.)”, and “general information”. For “sensitive information” with high importance, the unit applies a strong encryption algorithm such as AES-256 and a strict Access Control List (ACL), and further adds differential privacy noise. On the other hand, for “general information (e.g., weather data)” with low importance, the unit performs only lightweight encryption or hashing to reduce processing overhead. As subsequent processing, the unit sorts and stores the classified data in storage areas (secure enclave, etc.) having different security levels. This layering of protection according to data importance produces a technical effect of reliably protecting information to be protected while preventing performance degradation due to excessive security.

The privacy protection unit can estimate a user emotion and determine a priority of privacy protection based on the estimated user emotion. For example, the privacy protection unit preferentially performs detailed privacy protection when the user is relaxed. For example, the privacy protection unit preferentially performs privacy protection of important data when the user feels stress. For example, the privacy protection unit preferentially performs real-time privacy protection when the user is excited. Thereby, the privacy protection unit can determine the priority of privacy protection in accordance with the user emotion. The estimation of the emotion is realized using an emotion estimation function using, for example, an emotion engine or a generative AI. The generative AI is a text generative AI (e.g., LLM), a multimodal generative AI, or the like, but is not limited to such examples. Part or all of the above-described processing in the privacy protection unit may be performed using, for example, AI, or may be performed without using AI. For example, the privacy protection unit can input user emotion data into the generative AI and cause the generative AI to execute the determination of the priority of privacy protection. Specifically, the present privacy protection unit includes risk-based authentication and a protection task scheduler, and evaluates emotion data as one of risk factors. As input, the unit receives emotion data and a list of data protection tasks. When the user is in a state of “stress” or “panic”, the unit determines that the risk of erroneous operation or phishing fraud increases, and raises a priority of protection tasks (re-authentication request, immediate execution of anomaly detection scan) for critical data such as payment information and passwords to the highest level. On the other hand, in a calm state, the unit executes periodic data sanitization (harmlessness) processing in the background with a normal priority. As subsequent processing, the unit allocates security resources (CPU time, encryption accelerator) based on the priority. This prioritization based on emotion risk evaluation produces a technical effect of maximizing defense power at the moment when the user is in a vulnerable state and preventing security incidents before they happen.

The privacy protection unit can determine a priority of protection based on a collection time of the data during privacy protection. For example, the privacy protection unit preferentially protects the latest data and performs real-time privacy protection. For example, the privacy protection unit protects past data and performs long-term privacy protection. For example, the privacy protection unit preferentially protects data collected in a specific period and ensures privacy of that period. Thereby, the privacy protection unit enables efficient privacy protection by determining the priority of protection based on the collection time of the data. Part or all of the above-described processing in the privacy protection unit may be performed using, for example, AI, or may be performed without using AI. For example, the privacy protection unit can determine the priority of protection using an AI model that evaluates the collection time of data. Specifically, the present privacy protection unit transitions protection mechanisms according to an elapsed time (Age) of data based on a Data Lifecycle Management (DLM) policy. As input, the unit receives a timestamp and access frequency of data. Since “hot data” immediately after collection has the highest risk at the time of leakage and is frequently accessed, the unit performs real-time masking processing or tokenization and strictly protects it on memory. “Cold data” after a certain period of time has passed is moved to archive storage, subjected to high compression and strong encryption, and statically protected (Encryption at Rest). As subsequent processing, the unit automatically and completely erases data whose retention period has passed by an unrecoverable method (crypto-shredding, etc.). This protection strategy based on the time axis produces a technical effect of optimizing security costs in accordance with changes in data value and risk.

The feedback collection unit can estimate a user emotion and adjust a method of feedback collection based on the estimated user emotion. For example, the feedback collection unit collects detailed feedback when the user is relaxed. For example, the feedback collection unit collects simplified feedback when the user feels stress. For example, the feedback collection unit collects feedback in real time when the user is excited. Thereby, the feedback collection unit can adjust the method of feedback collection in accordance with the user emotion. The estimation of the emotion is realized using an emotion estimation function using, for example, an emotion engine or a generative AI. The generative AI is a text generative AI (e.g., LLM), a multimodal generative AI, or the like, but is not limited to such examples. Part or all of the above-described processing in the feedback collection unit may be performed using, for example, AI, or may be performed without using AI. For example, the feedback collection unit can input user emotion data into the generative AI and cause the generative AI to execute the adjustment of the method of feedback collection. Specifically, the present feedback collection unit has a generative UI function that dynamically generates a questionnaire form or an evaluation UI. Upon receiving an emotion score as input, if it is estimated that the user is “relaxed” and cooperative, the unit displays a detailed questionnaire form including a free description field to collect high-quality qualitative data. On the other hand, in a state of “stress” or “hurry”, the unit displays only a “like/dislike” button that is completed with one tap or a simple evaluation UI of a slider format to minimize user effort. As subsequent processing, the unit distributes data to an appropriate analysis pipeline according to the format of the collected feedback (text, numerical value, binary). This optimization of the collection interface according to the emotion produces a technical effect of improving a response rate and realizing continuous data collection without causing discomfort to the user.

The feedback collection unit can refer to a past feedback history of the user and select an optimal collection method when collecting feedback. For example, the feedback collection unit preferentially collects relevant questions based on feedback provided by the user in the past. For example, the feedback collection unit intensively collects feedback related to a specific category from the feedback history of the user. For example, the feedback collection unit analyzes the past feedback history of the user and selects the most effective collection method. Thereby, the feedback collection unit enables more effective feedback collection by referring to the past feedback history of the user and selecting the optimal collection method. Part or all of the above-described processing in the feedback collection unit may be performed using, for example, AI, or may be performed without using AI. For example, the feedback collection unit can input feedback history data of the user into the generative AI and cause the generative AI to execute the selection of the collection method. Specifically, the present feedback collection unit adopts an Active Learning strategy, and preferentially collects information regarding a region where Uncertainty of a model is highest. As input, the unit receives a past answer history of the user and a parameter distribution of a current user model. The present feedback collection unit omits questions for fields where user preferences are already clear (e.g., always rating “sports” highly), and generates questions for confirmation regarding fields where preferences are unclear (e.g., interest in “art”) or items where answers were contradictory in the past. As subsequent processing, the unit updates the model using the obtained answers to reduce uncertainty. This adaptive question generation based on history produces a technical effect of acquiring the maximum amount of information with the minimum number of questions and accelerating convergence of the user model.

The feedback collection unit can estimate a user emotion and determine a priority of feedback collection based on the estimated user emotion. For example, the feedback collection unit preferentially collects detailed feedback when the user is relaxed. For example, the feedback collection unit preferentially collects important feedback when the user feels stress. For example, the feedback collection unit preferentially collects real-time feedback when the user is excited. Thereby, the feedback collection unit can determine the priority of feedback collection in accordance with the user emotion. The estimation of the emotion is realized using an emotion estimation function using, for example, an emotion engine or a generative AI. The generative AI is a text generative AI (e.g., LLM), a multimodal generative AI, or the like, but is not limited to such examples. Part or all of the above-described processing in the feedback collection unit may be performed using, for example, AI, or may be performed without using AI. For example, the feedback collection unit can input user emotion data into the generative AI and cause the generative AI to execute the determination of the priority of feedback collection. Specifically, the present feedback collection unit is linked with an incident detection and Customer Satisfaction (CS) management system. Upon receiving emotion data as input, if the user shows a strong negative emotion such as “intense anger” or “disappointment”, the system determines this as a “critical incident” and sets a priority of feedback collection (hearing such as “What was the problem?”) regarding the immediately preceding advertisement display or system operation that caused it to the highest level. At this time, the collected data is immediately notified to an operation team as an alert. On the other hand, in the case of a positive emotion, the unit treats it as data for a normal improvement cycle and sets the priority to a standard level. As subsequent processing, the unit triggers a process of automatic apology or compensation (coupon distribution, etc.) for negative feedback. This collection based on emotion priority produces a technical effect of detecting and resolving user dissatisfaction at an early stage and preventing service cancellation (churn).

The feedback collection unit can consider geographical location information of the user and select an optimal collection method when collecting feedback. For example, when the user is in a specific area, the feedback collection unit collects feedback related to the area. For example, the feedback collection unit collects feedback related to a region-specific trend or event based on the geographical location information of the user. For example, when the user is traveling, the feedback collection unit collects feedback related to a visited area. Thereby, the feedback collection unit enables more effective feedback collection by considering the geographical location information of the user and selecting the optimal collection method. Part or all of the above-described processing in the feedback collection unit may be performed using, for example, AI, or may be performed without using AI. For example, the feedback collection unit can input the geographical location information of the user into the generative AI and cause the generative AI to execute the selection of the collection method. Specifically, the present feedback collection unit has a context-aware questionnaire generation function based on location information. The unit receives GPS coordinates and POI information as input, and detects that the user is staying at or has just stayed at a specific store or event venue (e.g., stadium). The present feedback collection unit generates a specific question related to the place (e.g., “How was the Wi-Fi environment at the stadium?”, “Was the advertisement for the nearby restaurant useful?”) and presents it to the user via push notification or the like. As subsequent processing, the unit maps the collected feedback with location information (geotagged data) on a map and creates an advertisement effect heat map for each area. This collection utilizing location information produces a technical effect of acquiring specific and fresh feedback linked to the context of place and improving the accuracy of area marketing.

The system according to the embodiment is not limited to the above-described examples, and various modifications are possible as follows, for example. Specifically, the present system can be implemented in a distributed manner using a lightweight AI model (a model to which quantization or distillation technology is applied) not only in a cloud computing environment but also in an edge computing environment (within a user's smartphone or IoT device). In addition, the system has an architecture that can be flexibly expanded and changed in accordance with future technical trends and platform evolution, such as a configuration in which blockchain technology is introduced to manage user data provision history and advertisement viewing rewards on a tamper-proof distributed ledger, and a configuration in which behavior data of an avatar in a metaverse space is included in analysis targets.

The advertisement generation system can consider a past purchase history of the user when analyzing the user search data or the interaction data with the generative AI. For example, the collection unit collects data on products and services purchased by the user in the past and provides the data to the analysis unit. The analysis unit analyzes the collected purchase history data and identifies a purchase tendency of the user. The generation unit generates an advertisement related to a product or service that the user is highly likely to purchase again based on the purchase tendency identified by the analysis unit. The provision unit displays the generated advertisement on a web page or application browsed by the user. Thereby, the advertisement generation system can provide a more effective advertisement by considering the purchase history of the user. Specifically, the present system includes a purchase prediction model (e.g., a model combining RFM analysis and deep learning) that takes transaction data (purchase date and time, product ID, amount, quantity) acquired in cooperation with an EC site or a POS system as input. The analysis unit learns a purchase cycle (repeat cycle) of products and a cross-selling rule (association analysis result) from the purchase history data, and predicts a timing when the user will need a specific product next with high accuracy. The generation unit generates a reminder advertisement such as “How about replenishing soon?” or a cross-sell advertisement proposing a related accessory of a purchased product in accordance with the predicted timing. As subsequent processing, when a purchase via an advertisement occurs, the system feeds back the data to the model as a new correct label to continuously improve prediction accuracy. This prediction based on purchase history produces a technical effect of making a timely proposal closely related to the user's lifestyle and maximizing Customer Lifetime Value (LTV).

The advertisement generation system can consider social media activity of the user when analyzing the user search data or the interaction data with the generative AI. For example, the collection unit collects data on topics frequently mentioned by the user on social media or accounts followed by the user, and provides the data to the analysis unit. The analysis unit analyzes the collected social media data and identifies a field of interest of the user. The generation unit generates an advertisement in which the user is highly likely to be interested based on the field of interest identified by the analysis unit. The provision unit displays the generated advertisement on a web page or application browsed by the user. Thereby, the advertisement generation system can provide a more effective advertisement by considering the social media activity of the user. Specifically, the present system includes a multimodal SNS analysis engine combining Natural Language Processing (NLP) and image recognition. Input data is text and photos posted by the user, shared URLs, and “liked” content. The analysis unit extracts sentiment (emotion) and keywords from the text, detects objects and scenes (e.g., sea, cafe, cat) from the photos, and generates a “Lifestyle Fingerprint” vector of the user. Using this vector, the generation unit generates an “Instagrammable” visual that the user would like to share on SNS or an advertisement with a story that evokes empathy. As subsequent processing, when the advertisement is shared on SNS, the system tracks its diffusion path and measures a viral effect. This analysis based on SNS activity produces a technical effect of deploying an advertisement appealing to the user's desire for self-expression and sense of belonging, and promoting organic diffusion.

The advertisement generation system can consider geographical location information of the user when analyzing user search data or interaction data with a generative AI. For example, the collection unit collects current geographical location information of the user and provides it to the analysis unit. The analysis unit analyzes the collected geographical location information and identifies trends and events related to an area where the user is currently located. The generation unit generates an advertisement in which the user is likely to be interested based on the trends and events of the area identified by the analysis unit. The provision unit displays the generated advertisement on a web page or an application viewed by the user. Thereby, the advertisement generation system can provide a more effective advertisement by considering the geographical location information of the user. Specifically, the present system has a geo-targeting engine that integrates a Geographic Information System (GIS) and a real-time event database. As input, the system receives real-time location coordinates of the user and information on weather, traffic conditions, and ongoing events in the area. The analysis unit infers that, for example, if conditions of “rainy weather” and “around a station” are met, demand for a “cafe for shelter from rain” or a “taxi dispatch application” increases. Based on this inference, the generation unit generates an advertisement copy and a map image emphasizing immediacy, such as “coupon usable right now” or “3 minutes from current location”. As subsequent processing, the system verifies whether the user actually visited the store (store visit conversion) using a GPS log. By utilizing this dynamic location and environmental information, a technical effect is achieved in which a solution matching a physical situation of the user is presented to encourage behavioral change in the real world.

The advertisement generation system can consider device information of the user when analyzing user search data or interaction data with a generative AI. For example, the collection unit collects data such as a type, screen size, and resolution of a device used by the user, and provides the data to the analysis unit. The analysis unit analyzes the collected device information and identifies an advertisement format optimal for the user's device. The generation unit generates an advertisement optimal for the user's device based on the advertisement format identified by the analysis unit. The provision unit displays the generated advertisement on a web page or an application viewed by the user. Thereby, the advertisement generation system can provide a more effective advertisement by considering the device information of the user. Specifically, the present system includes an environment analysis module that determines hardware performance (GPU performance, memory capacity) of the device and a network environment (5G, Wi-Fi, 4G). As input, the system receives fingerprint information of a browser and network bandwidth measurement values. The analysis unit determines that a high-resolution 4K video or a 3D interactive advertisement (using WebGL) can be displayed for a user using a high-speed line on a high-end smartphone or PC, while determining to select a lightweight still image or text advertisement for a user with a low-end device or in a low-speed line environment. Based on this determination, the generation unit automatically generates (transcodes) different variations such as a rich media version and a lightweight version from the same advertisement campaign material. As subsequent processing, the system monitors load time and rendering completion rate of the advertisement to maintain distribution quality. By this content optimization according to device capability, a technical effect is obtained in which technical constraints in a viewing environment of the user are overcome and a highest quality experience is always provided.

The advertisement generation system can consider a past advertisement reaction history of the user when analyzing user search data or interaction data with a generative AI. For example, the collection unit collects data on advertisements clicked or skipped by the user in the past and provides the data to the analysis unit. The analysis unit analyzes the collected advertisement reaction history data and identifies a reaction tendency of the user toward advertisements. The generation unit generates an advertisement in which the user is likely to be interested based on the reaction tendency identified by the analysis unit. The provision unit displays the generated advertisement on a web page or an application viewed by the user. Thereby, the advertisement generation system can provide a more effective advertisement by considering the past advertisement reaction history of the user. Specifically, the present system utilizes a deep learning model (e.g., DeepFM or Wide & Deep) that performs Click-Through Rate (CTR) prediction and Conversion Rate (CVR) prediction. Input data is a time-series log of a user ID, an advertisement ID, and a past interaction history (click, impression, skip, conversion). The analysis unit learns a “reaction tendency vector” for each user from these data and identifies what kind of color, keyword, and appeal axis (price appeal or quality appeal) the user is likely to react to. The generation unit constructs an advertisement with a combination of elements that maximizes a reaction probability. As subsequent processing, an actual reaction result is fed back to the model, and the model is updated as needed by online learning. By this continuous optimization based on the reaction history, a technical effect is achieved in which wasted advertisements are reduced and ROI (Return On Investment) is maximized.

The advertisement generation system can estimate a user emotion and adjust a display timing of the advertisement based on the estimated emotion. For example, the collection unit collects facial expression or voice data of the user and provides the data to the analysis unit. The analysis unit analyzes the collected data and estimates the user emotion. The generation unit adjusts the display timing of the advertisement based on the estimated emotion. For example, when the user is relaxed, the advertisement can be displayed frequently, and when the user feels stressed, a display frequency of the advertisement can be reduced. The provision unit provides the advertisement to the user at the adjusted timing. Thereby, the advertisement generation system can provide a more effective advertisement by adjusting the display timing of the advertisement in accordance with the user emotion. Specifically, the present system uses an emotional state transition model (such as a Hidden Markov Model) to predict a change pattern of the user emotion and identify a “golden moment” when advertisement receptivity increases. As input, the system receives time-series data of an emotion score estimated from real-time biometric data (facial expression, voice) or an operation log. The analysis unit predicts not only a current emotional state but also an emotional state after several seconds to several minutes. The generation unit and the provision unit queue an advertisement request in accordance with a timing predicted that the user will shift to a positive emotion, and generate a control signal to suppress advertisement display at a peak of a negative emotion. As subsequent processing, a click rate for each display timing is analyzed to fine-tune timing determination logic. By this timing control based on emotion prediction, a technical effect is obtained in which information is presented at a rhythm comfortable for the user, and the advertisement is sublimated from a “nuisance” to “useful information”.

The advertisement generation system can estimate a user emotion and adjust content of the advertisement based on the estimated emotion. For example, the collection unit collects facial expression or voice data of the user and provides the data to the analysis unit. The analysis unit analyzes the collected data and estimates the user emotion. The generation unit adjusts the content of the advertisement based on the estimated emotion. For example, when the user is relaxed, an advertisement with a gentle tone can be generated, and when the user is excited, a visually stimulating advertisement can be generated. The provision unit provides the advertisement with the adjusted content to the user. Thereby, the advertisement generation system can provide a more effective advertisement by adjusting the content of the advertisement in accordance with the user emotion. Specifically, the present system adopts an Emotion-Conditioned Generative Model and incorporates an input emotion label as a latent variable into an advertisement generation process. As input, the system receives a current emotion vector of the user (e.g., [joy: 0.8, surprise: 0.2]). The generation unit uses this vector as a style guide to adjust a color palette or a filter effect in image generation, and selection of adjectives or sentence-ending expressions in text generation. For example, when an emotion of “sadness” is detected, a warm message and image showing encouragement or empathy are generated to stay close to the user emotion. As subsequent processing, an emotion analysis AI self-evaluates whether the generated content contains an intended emotional tone to ensure quality. By this content generation aiming for emotional resonance, a technical effect is achieved in which a psychological bond with the user is strengthened and brand loyalty is enhanced.

The advertisement generation system can estimate a user emotion and adjust a length of the advertisement based on the estimated emotion. For example, the collection unit collects facial expression or voice data of the user and provides the data to the analysis unit. The analysis unit analyzes the collected data and estimates the user emotion. The generation unit adjusts the length of the advertisement based on the estimated emotion. For example, when the user is relaxed, a longer advertisement can be generated, and when the user is in a hurry, a short and to-the-point advertisement can be generated. The provision unit provides the advertisement with the adjusted length to the user. Thereby, the advertisement generation system can provide a more effective advertisement by adjusting the length of the advertisement in accordance with the user emotion. Specifically, the present system has a function of estimating a cognitive load of the user and controlling an amount of information. As input, the system receives behavioral data such as eye movement and scroll speed in addition to emotion data. The analysis unit determines whether the user has room to process information (cognitive spare capacity). When the cognitive spare capacity is large (relaxed state), the generation unit generates a long video including storytelling or a detailed product description text to encourage deep understanding. Conversely, when the cognitive spare capacity is small (impatience, high load state), the generation unit generates a bumper advertisement within 5 seconds or a simple image with only a catchphrase to aim for instantaneous recognition. As subsequent processing, a viewing completion rate of the advertisement is measured to learn an optimal value of the length. By this information amount control according to the cognitive load, a technical effect is obtained in which a message is transmitted without giving stress to the user and communication efficiency is maximized.

The advertisement generation system can estimate a user emotion and adjust a display format of the advertisement based on the estimated emotion. For example, the collection unit collects facial expression or voice data of the user and provides the data to the analysis unit. The analysis unit analyzes the collected data and estimates the user emotion. The generation unit adjusts the display format of the advertisement based on the estimated emotion. For example, when the user is relaxed, a still image or text-based advertisement can be displayed, and when the user is excited, an advertisement using a video or animation can be displayed. The provision unit provides the advertisement in the adjusted format to the user. Thereby, the advertisement generation system can provide a more effective advertisement by adjusting the display format of the advertisement in accordance with the user emotion. Specifically, the present system includes a media format selector and switches between static/dynamic content according to emotional arousal. As input, the system receives an arousal score (0 to 1). When the arousal is high (excited state), the analysis unit determines that the user is seeking stimulation and selects rich media with visual movement (video, GIF animation, carousel). When the arousal is low (calm state), the analysis unit determines that the user prefers a quiet environment and selects a native advertisement with only a still image or text. The generation unit synthesizes and renders materials according to the selected format. As subsequent processing, an engagement rate for each format is comparatively analyzed. By this format selection adapted to an arousal level, a technical effect is achieved in which advertisement presentation matching a physiological receptivity of the user is performed, and attention is attracted while avoiding discomfort.

The advertisement generation system can estimate a user emotion and adjust targeting accuracy of the advertisement based on the estimated emotion. For example, the collection unit collects facial expression or voice data of the user and provides the data to the analysis unit. The analysis unit analyzes the collected data and estimates the user emotion. The generation unit adjusts the targeting accuracy of the advertisement based on the estimated emotion. For example, when the user is relaxed, broad targeting can be performed, and when the user feels stressed, more precise targeting can be performed. The provision unit provides the advertisement with the adjusted targeting accuracy to the user. Thereby, the advertisement generation system can provide a more effective advertisement by adjusting the targeting accuracy of the advertisement in accordance with the user emotion. Specifically, the present system implements a bandit algorithm that dynamically controls a balance between exploration and exploitation according to the emotion. As input, the system receives an emotion score. When the user feels “relaxed” or “bored”, the system strengthens an “exploration” mode and presents a highly novel advertisement (emphasizing serendipity) outside a known interest range of the user to dig up potential interest. On the other hand, in a state of “stress” or “goal-oriented”, the system strengthens an “exploitation” mode and presents only a highly accurate targeting advertisement (emphasizing relevance) known to be of interest from a past history to reduce noise. As subsequent processing, a width of interest (diversity) of the user is updated by observing a reaction to the presented advertisement. By this switching of exploration/exploitation strategies based on emotion, a technical effect is obtained in which “new discovery” and “reliable information” are used properly according to a mood of the user, and long-term engagement is maintained.

Hereinafter, a flow of processing of Example of the Embodiment will be briefly described. Specifically, a data processing pipeline in the present system is implemented as a series of microservices operating on a distributed processing framework (e.g., Apache Kafka or Spark Streaming), and each step is executed asynchronously and in parallel, thereby ensuring scalability capable of responding with low latency on the order of milliseconds even for a large-scale user base.

Step 1: The collection unit collects user search data or interaction data with a generative AI. The user search data includes, for example, a keyword input in a search engine and a search history. The interaction data with the generative AI includes, for example, content of interaction performed by the user with the generative AI and a history of interaction. The collection unit collects these data and provides them to the analysis unit. Step 2: The analysis unit analyzes the data collected by the collection unit and identifies user hobbies and preferences. The analysis unit identifies a topic or product in which the user is interested from the user's search history or interaction content using, for example, natural language processing technology. The analysis unit can use the generative AI to identify the user hobbies and preferences. The generative AI analyzes the user's search history or interaction content using, for example, a text generation AI (e.g., LLM) and identifies the user hobbies and preferences. Step 3: The generation unit generates an advertisement based on the hobbies and preferences identified by the analysis unit. The generation unit automatically creates, for example, an advertisement related to a product or service in which the user is interested. The generation unit can generate the advertisement using the generative AI. The generative AI generates the advertisement based on the user hobbies and preferences using, for example, a text generation AI (e.g., LLM). Step 4: The provision unit provides the advertisement generated by the generation unit to the user. The provision unit displays, for example, the generated advertisement on a web page or an application viewed by the user. The provision unit can provide the advertisement using the generative AI. Specifically, in Step 1, the collection unit normalizes raw data from heterogeneous data sources, converts the data into a common data schema (Protocol Buffers, etc.), and puts the data into a message queue. In Step 2, the analysis unit retrieves the data from the queue, performs vectorization and inference processing, and updates a user profile database (Key-Value store). In Step 3, the generation unit uses the updated profile as a trigger to cause a generation model to perform inference on a GPU cluster, generates an advertisement creative, and stores it in a cache server. In Step 4, upon receiving an advertisement request (Ad Request) from the user, the provision unit immediately acquires an optimal creative from the cache and returns it as an HTTP response. Each step in this series of flows cooperates at high speed while maintaining data consistency, achieving a technical effect of realizing real-time personalization.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of a plurality of elements including the above-described collection unit, analysis unit, generation unit, provision unit, privacy protection unit, and feedback collection unit is implemented by, for example, at least one of a smart device 14 and a data processing apparatus 12. For example, the collection unit is implemented by a control unit 46A of the smart device 14, and collects user search data and interaction data with a generative AI. The analysis unit is implemented by, for example, a specific processing unit 290 of the data processing apparatus 12, and analyzes the collected data to identify user hobbies and preferences. The generation unit is implemented by, for example, the specific processing unit 290 of the data processing apparatus 12, and generates an advertisement based on the identified hobbies and preferences. The provision unit is implemented by, for example, the control unit 46A of the smart device 14, and provides the generated advertisement to the user. The privacy protection unit is implemented by, for example, the specific processing unit 290 of the data processing apparatus 12, and performs anonymization or encryption of data. The feedback collection unit is implemented by, for example, the control unit 46A of the smart device 14, and collects user feedback to measure an effect of the advertisement. The correspondence relationship between each unit and the apparatus or the control unit is not limited to the above-described example, and various modifications are possible.

### Second Embodiment

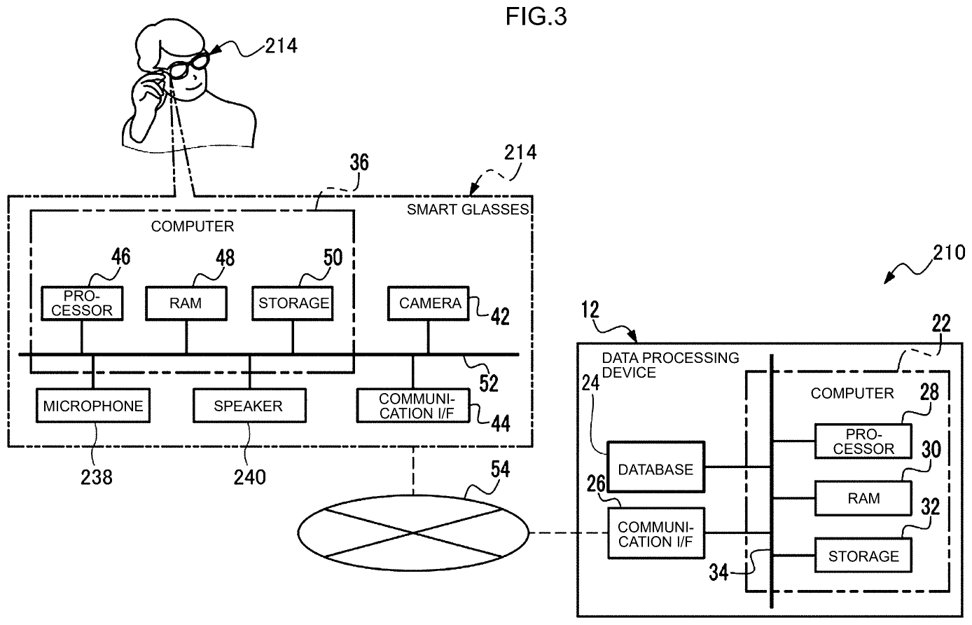

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

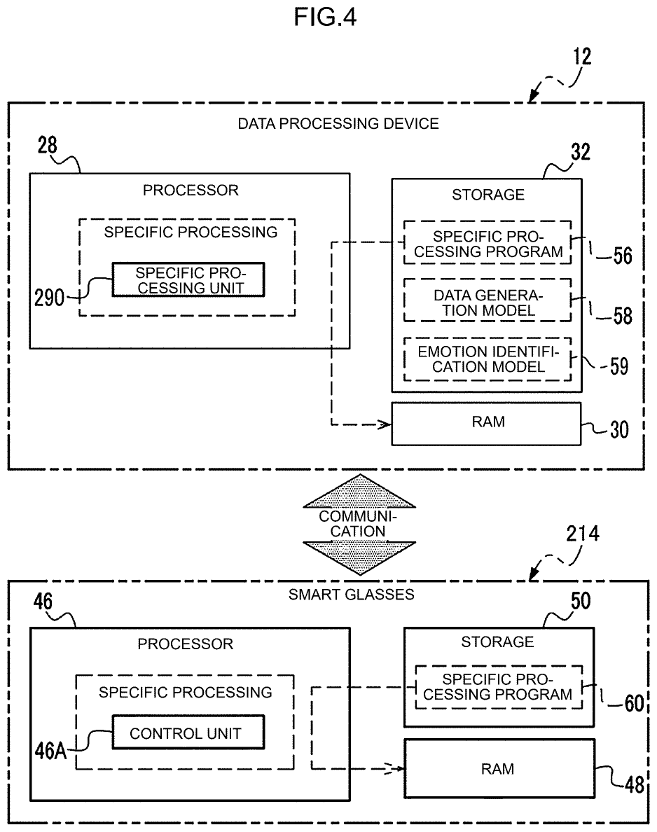

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of a plurality of elements including the above-described collection unit, analysis unit, generation unit, provision unit, privacy protection unit, and feedback collection unit is implemented by, for example, at least one of smart glasses 214 and the data processing apparatus 12. For example, the collection unit is implemented by a control unit 46A of the smart glasses 214, and collects user search data and interaction data with a generative AI. The analysis unit is implemented by, for example, a specific processing unit 290 of the data processing apparatus 12, and analyzes the collected data to identify user hobbies and preferences. The generation unit is implemented by, for example, the specific processing unit 290 of the data processing apparatus 12, and generates an advertisement based on the identified hobbies and preferences. The provision unit is implemented by, for example, the control unit 46A of the smart glasses 214, and provides the generated advertisement to the user. The privacy protection unit is implemented by, for example, the specific processing unit 290 of the data processing apparatus 12, and performs anonymization or encryption of data. The feedback collection unit is implemented by, for example, the control unit 46A of the smart glasses 214, and collects user feedback to measure an effect of the advertisement. The correspondence relationship between each unit and the apparatus or the control unit is not limited to the above-described example, and various modifications are possible.

### Third Embodiment

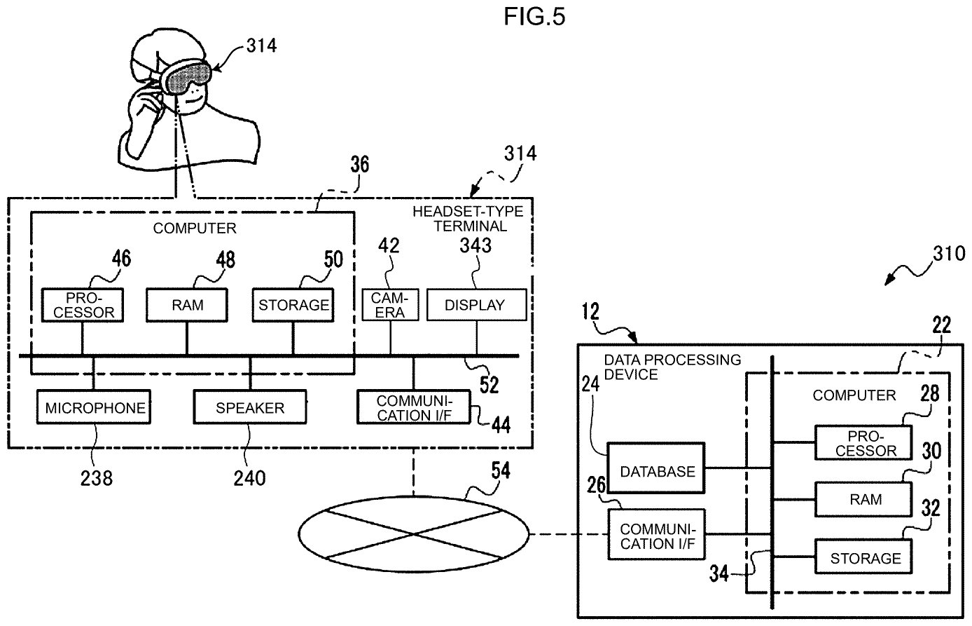

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

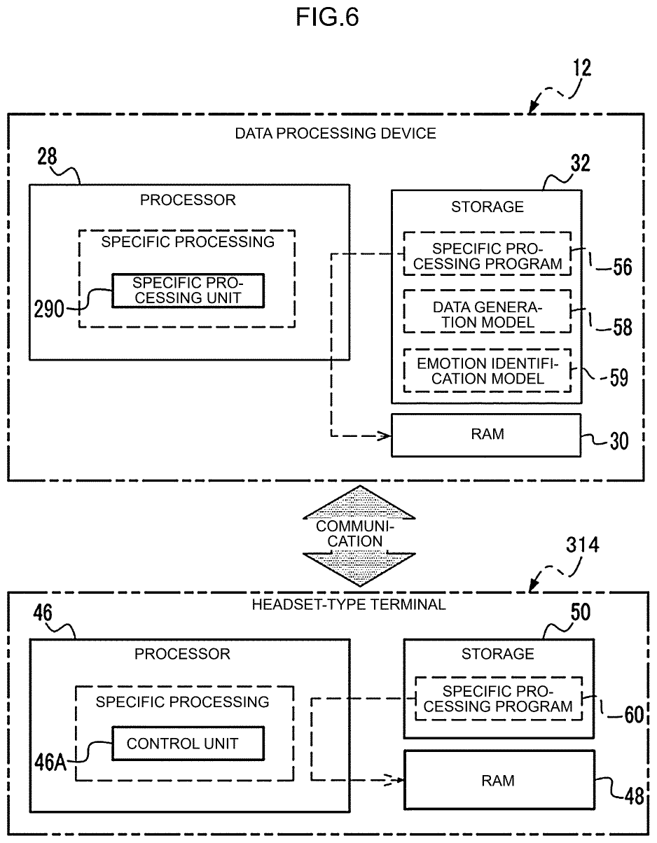

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of a plurality of elements including the above-described collection unit, analysis unit, generation unit, provision unit, privacy protection unit, and feedback collection unit is implemented by, for example, at least one of a headset-type terminal 314 and the data processing apparatus 12. For example, the collection unit is implemented by a control unit 46A of the headset-type terminal 314, and collects user search data and interaction data with a generative AI. The analysis unit is implemented by, for example, a specific processing unit 290 of the data processing apparatus 12, and analyzes the collected data to identify user hobbies and preferences. The generation unit is implemented by, for example, the specific processing unit 290 of the data processing apparatus 12, and generates an advertisement based on the identified hobbies and preferences. The provision unit is implemented by, for example, the control unit 46A of the headset-type terminal 314, and provides the generated advertisement to the user. The privacy protection unit is implemented by, for example, the specific processing unit 290 of the data processing apparatus 12, and performs anonymization or encryption of data. The feedback collection unit is implemented by, for example, the control unit 46A of the headset-type terminal 314, and collects user feedback to measure an effect of the advertisement. The correspondence relationship between each unit and the apparatus or the control unit is not limited to the above-described example, and various modifications are possible.

### Fourth Embodiment

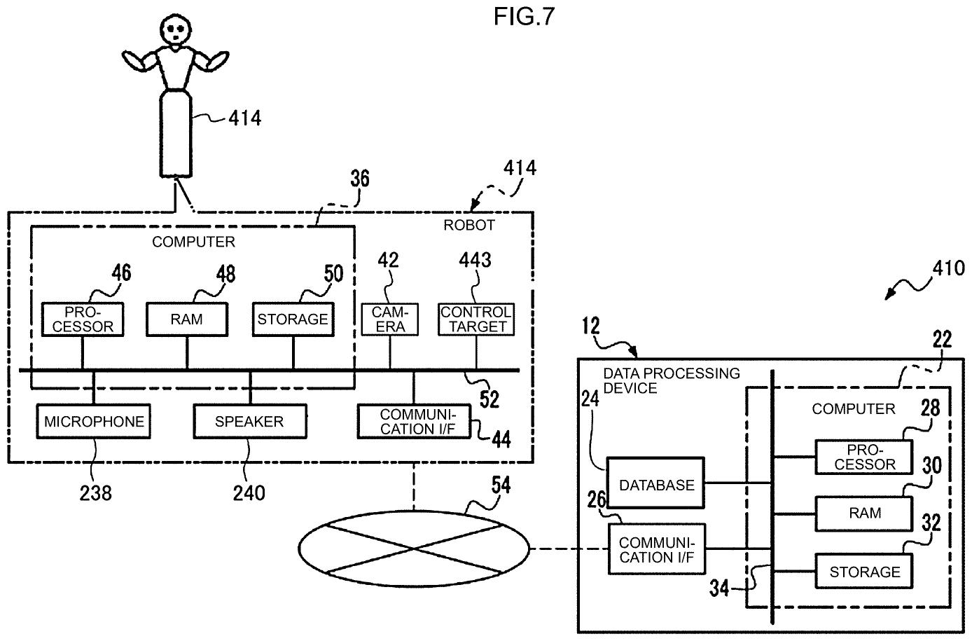

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

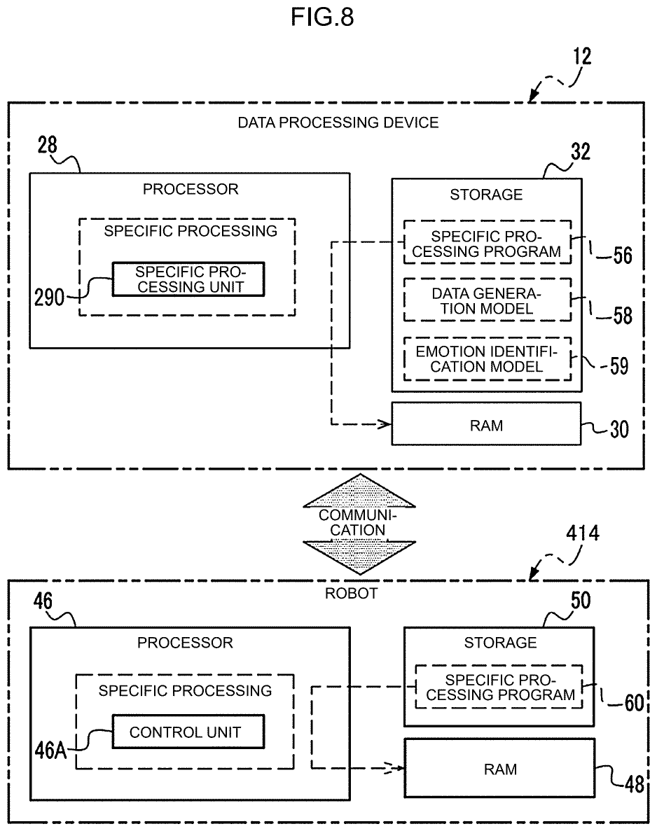

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of a plurality of elements including the above-described collection unit, analysis unit, generation unit, provision unit, privacy protection unit, and feedback collection unit is implemented by, for example, at least one of a robot 414 and the data processing apparatus 12. For example, the collection unit is implemented by a control unit 46A of the robot 414, and collects user search data and interaction data with a generative AI. The analysis unit is implemented by, for example, a specific processing unit 290 of the data processing apparatus 12, and analyzes the collected data to identify user hobbies and preferences. The generation unit is implemented by, for example, the specific processing unit 290 of the data processing apparatus 12, and generates an advertisement based on the identified hobbies and preferences. The provision unit is implemented by, for example, the control unit 46A of the robot 414, and provides the generated advertisement to the user. The privacy protection unit is implemented by, for example, the specific processing unit 290 of the data processing apparatus 12, and performs anonymization or encryption of data. The feedback collection unit is implemented by, for example, the control unit 46A of the robot 414, and collects user feedback to measure an effect of the advertisement. The correspondence relationship between each unit and the apparatus or the control unit is not limited to the above-described example, and various modifications are possible.

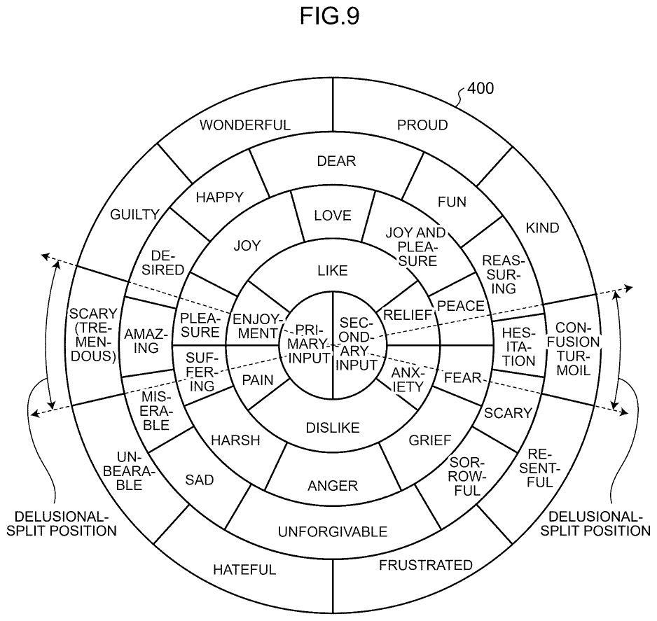

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

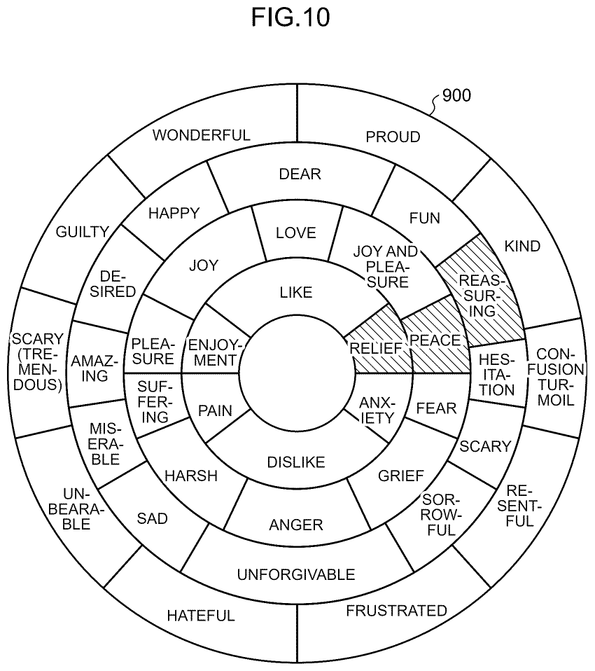

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a collection unit configured to collect user search data or interaction data with a generative AI; an analysis unit configured to analyze the data collected by the collection unit and identify user hobbies and preferences; a generation unit configured to generate an advertisement based on the hobbies and preferences identified by the analysis unit; and a provision unit configured to provide the advertisement generated by the generation unit to the user.

(Supplementary Note 2) The system according to Supplementary Note 1, further comprising a privacy protection unit configured to protect user privacy in a process of collecting and analyzing the data.

(Supplementary Note 3) The system according to Supplementary Note 1, further comprising a feedback collection unit configured to collect user feedback and measure an effect of the advertisement.

(Supplementary Note 4) The system according to Supplementary Note 1, wherein the collection unit is configured to estimate a user emotion and adjust a collection timing of the search data in accordance with the estimated user emotion.

(Supplementary Note 5) The system according to Supplementary Note 1, wherein the collection unit is configured to analyze a past search history of the user and select an appropriate collection method.

(Supplementary Note 6) The system according to Supplementary Note 1, wherein the collection unit is configured to perform filtering based on a current field of interest of the user when collecting the search data.

(Supplementary Note 7) The system according to Supplementary Note 1, wherein the collection unit is configured to estimate a user emotion and determine a priority of data to be collected based on the estimated user emotion.

(Supplementary Note 8) The system according to Supplementary Note 1, wherein the collection unit is configured to preferentially collect highly relevant data based on geographical location information of the user when collecting the search data.

(Supplementary Note 9) The system according to Supplementary Note 1, wherein the collection unit is configured to analyze social media activity of the user and collect relevant data when collecting the search data.

(Supplementary Note 10) The system according to Supplementary Note 1, wherein the analysis unit is configured to estimate a user emotion and adjust a data analysis method based on the estimated user emotion.

(Supplementary Note 11) The system according to Supplementary Note 1, wherein the analysis unit is configured to adjust a level of detail of analysis based on an importance of the data during analysis.

(Supplementary Note 12) The system according to Supplementary Note 1, wherein the analysis unit is configured to apply different analysis algorithms according to a category of the data during analysis.

(Supplementary Note 13) The system according to Supplementary Note 1, wherein the analysis unit is configured to estimate a user emotion and determine a priority of analysis based on the estimated user emotion.

(Supplementary Note 14) The system according to Supplementary Note 1, wherein the analysis unit is configured to determine a priority of analysis based on a collection time of the data during analysis.

(Supplementary Note 15) The system according to Supplementary Note 1, wherein the analysis unit is configured to adjust an order of analysis based on a relevance of the data during analysis.

(Supplementary Note 16) The system according to Supplementary Note 1, wherein the generation unit is configured to estimate a user emotion and adjust a presentation method of the advertisement based on the estimated user emotion.

(Supplementary Note 17) The system according to Supplementary Note 1, wherein the generation unit is configured to adjust content of the advertisement based on a level of detail of the user hobbies and preferences when generating the advertisement.

(Supplementary Note 18) The system according to Supplementary Note 1, wherein the generation unit is configured to apply different generation algorithms according to an interest category of the user when generating the advertisement.

(Supplementary Note 19) The system according to Supplementary Note 1, wherein the generation unit is configured to estimate a user emotion and adjust a length of the advertisement based on the estimated user emotion.

(Supplementary Note 20) The system according to Supplementary Note 1, wherein the generation unit is configured to determine a priority of the advertisement based on a past advertisement reaction history of the user when generating the advertisement.

(Supplementary Note 21) The system according to Supplementary Note 1, wherein the generation unit is configured to adjust an order of the advertisement based on a relevance to the user when generating the advertisement.

(Supplementary Note 22) The system according to Supplementary Note 1, wherein the provision unit is configured to estimate a user emotion and adjust a provision method of the advertisement based on the estimated user emotion.

(Supplementary Note 23) The system according to Supplementary Note 1, wherein the provision unit is configured to refer to a browsing history of the user and select an appropriate provision method when providing the advertisement.

(Supplementary Note 24) The system according to Supplementary Note 1, wherein the provision unit is configured to customize a provision method based on device information of the user when providing the advertisement.

(Supplementary Note 25) The system according to Supplementary Note 1, wherein the provision unit is configured to estimate a user emotion and adjust a provision timing of the advertisement based on the estimated user emotion.

(Supplementary Note 26) The system according to Supplementary Note 1, wherein the provision unit is configured to select an appropriate provision method based on geographical location information of the user when providing the advertisement.

(Supplementary Note 27) The system according to Supplementary Note 1, wherein the provision unit is configured to analyze social media activity of the user and adjust a provision method when providing the advertisement.

(Supplementary Note 28) The system according to Supplementary Note 2, wherein the privacy protection unit is configured to estimate a user emotion and adjust a method of privacy protection based on the estimated user emotion.

(Supplementary Note 29) The system according to Supplementary Note 2, wherein the privacy protection unit is configured to adjust a level of detail of protection based on an importance of the data during privacy protection.

(Supplementary Note 30) The system according to Supplementary Note 2, wherein the privacy protection unit is configured to estimate a user emotion and determine a priority of privacy protection based on the estimated user emotion.

(Supplementary Note 31) The system according to Supplementary Note 2, wherein the privacy protection unit is configured to determine a priority of protection based on a collection time of the data during privacy protection.

(Supplementary Note 32) The system according to Supplementary Note 3, wherein the feedback collection unit is configured to estimate a user emotion and adjust a method of feedback collection based on the estimated user emotion.

(Supplementary Note 33) The system according to Supplementary Note 3, wherein the feedback collection unit is configured to refer to a past feedback history of the user and select an optimal collection method when collecting feedback.

(Supplementary Note 34) The system according to Supplementary Note 3, wherein the feedback collection unit is configured to estimate a user emotion and determine a priority of feedback collection based on the estimated user emotion.

(Supplementary Note 35) The system according to Supplementary Note 3, wherein the feedback collection unit is configured to consider geographical location information of the user and select an optimal collection method when collecting feedback.

What is claimed is:

1. A system comprising:
circuitry configured to:
receive, via a packet-switched network from a terminal device, query data comprising a sequence of input tokens and session data associated with a data generation model;
generate, by inputting the query data into a Transformer-based analysis model, a feature vector representing a multidimensional distribution of classification labels associated with the query data;
generate output content data by inputting the feature vector as a conditioning input into the data generation model, the data generation model comprising a neural network trained by deep learning to generate inference data based on the feature vector; and
transmit the output content data via the packet-switched network to the terminal device.

2. The system according to claim 1, wherein the query data comprises search query strings input by a user into a search engine, and the session data comprises interaction logs between the user and a generative artificial intelligence.

3. The system according to claim 1, wherein the output content data comprises an advertisement tailored to user hobbies and preferences identified from the classification labels.

4. The system according to claim 1, wherein the circuitry is further configured to apply a named entity recognition model to the query data and mask personally identifiable information detected in the query data prior to generating the feature vector.

5. The system according to claim 4, wherein the circuitry is further configured to inject statistical noise into the query data using differential privacy to conceal individual user data while maintaining statistical usefulness of the query data.

6. The system according to claim 1, wherein the circuitry is further configured to collect feedback data comprising a click-through indicator, a dwell time value, and a sentiment score computed by applying a sentiment analysis model to text feedback received from the terminal device, and to compute a reward scalar from the feedback data for fine-tuning the data generation model using reinforcement learning from human feedback.

7. The system according to claim 1, wherein the circuitry is further configured to estimate a user emotion by inputting facial image data and audio waveform data received from the terminal device into an emotion estimation model comprising a convolutional neural network and a recurrent neural network, and to adjust a sampling rate of the query data based on the estimated user emotion.

8. The system according to claim 1, wherein the circuitry is further configured to input a time-series vector of search activity into a long short-term memory network to predict an activity level of a user in a future time frame, and to adjust a polling interval for receiving the query data based on the predicted activity level.

9. The system according to claim 1, wherein the circuitry is further configured to input the query data into a topic classification model applying latent Dirichlet allocation to generate a topic cluster identifier and a belonging probability, compute a cosine similarity between a current interest vector of a user and a topic vector of the query data, and discard the query data when the cosine similarity is below a predetermined threshold.

10. The system according to claim 1, wherein the circuitry is further configured to determine a priority score for the query data based on an emotion label output from an emotion estimation model, and to schedule collection tasks in a priority queue sorted by the priority score.

11. The system according to claim 1, wherein the circuitry is further configured to receive geographical location data from the terminal device, determine a location context of a user by applying a clustering algorithm to the geographical location data, and adjust a collection depth of the query data based on the determined location context.

12. The system according to claim 1, wherein the circuitry is further configured to collect social media activity data of a user from the terminal device, extract interaction patterns from the social media activity data using a social graph analysis model, and append the interaction patterns to the query data.

13. The system according to claim 1, wherein the circuitry is further configured to calculate an importance score for each element of the query data by applying an attention mechanism, execute full-path inference using all layers of a deep neural network for elements whose importance score exceeds a threshold, and apply an early exit method using shallow layers for elements whose importance score is below the threshold.

14. The system according to claim 1, wherein the circuitry is further configured to determine a modality of the query data by analyzing header information, apply a Transformer-based model to extract a semantic vector when the modality is text, and apply a convolutional neural network to extract an image feature vector when the modality is image.

15. The system according to claim 1, wherein the circuitry is further configured to estimate a user emotion and adjust a presentation format of the output content data based on the estimated user emotion, wherein the presentation format comprises at least one of a visual layout, a text length, and a color scheme.

16. The system according to claim 1, wherein the circuitry is further configured to select a provision method for the output content data based on device information received from the terminal device, the device information comprising at least one of a screen size, a display resolution, and an operating system identifier.

17. The system according to claim 1, wherein the circuitry is further configured to determine a provision timing for the output content data based on a browsing history received from the terminal device and an emotion state estimated from the session data.

18. A system comprising:
circuitry configured to:
receive, via a packet-switched network from a terminal device, query data comprising a sequence of input tokens obtained by tokenizing search query strings, and session data comprising time-series text data of interactions with a data generation model;
generate a current interest vector by inputting the query data into a topic classification model that applies latent Dirichlet allocation, the current interest vector representing a belonging probability for each of a plurality of topic clusters;
generate, by inputting the query data and the current interest vector into a Transformer-based analysis model comprising an encoder that performs context analysis on the sequence of input tokens, a feature vector expressed as a multidimensional distribution of affinity scores for a plurality of classification categories;
generate output content data by inputting the feature vector as a conditioning input into the data generation model, the data generation model comprising a neural network obtained by performing deep learning and configured to generate pixel data of an image as a multidimensional tensor and text data based on the feature vector;
compute a quality score for the output content data and select only output content data whose quality score exceeds a predetermined quality threshold; and
transmit the selected output content data via the packet-switched network to the terminal device for rendering on a display of the terminal device.

19. The system according to claim 18, wherein the circuitry is further configured to collect feedback data comprising a click-through indicator and a dwell time value associated with the output content data, compute a sentiment score by applying a sentiment analysis model to text feedback received from the terminal device, integrate the click-through indicator, the dwell time value, and the sentiment score into a reward scalar, and update weight parameters of the data generation model based on the reward scalar using reinforcement learning from human feedback.

20. A method performed by circuitry of a system, the method comprising:
receiving, via a packet-switched network from a terminal device, query data comprising a sequence of input tokens and session data associated with a data generation model;
generating, by inputting the query data into a Transformer-based analysis model, a feature vector representing a multidimensional distribution of classification labels associated with the query data;
generating output content data by inputting the feature vector as a conditioning input into the data generation model, the data generation model comprising a neural network trained by deep learning to generate inference data based on the feature vector; and
transmitting the output content data via the packet-switched network to the terminal device.
